(19) United States
(12) Patent Application Publication
(10) Pub. No.: US 2024/0002175 A1
(43) Pub. Date: Jan. 4, 2024

(54) Methods, Systems and Devices for Efficient and Rapid Autonomous Delivery of Goods

(71) Applicant: Kevin D. McGushion, Clearwater, FL (US)

(72) Inventor: Kevin D. McGushion, Clearwater, FL (US)

(21) Appl. No.: 18/217,829

(22) Filed: Jul. 3, 2023

Related U.S. Application Data
(60) Provisional application No. 63/358,077, filed on Jul. 1, 2022.
(60) Provisional application No. 63/358,032, filed on Jul. 1, 2022.

(51) Int. Cl. B65G 67/02; B61B 1/00

(52) U.S. Cl. CPC B65G 67/02; B61B 1/005

(57) ABSTRACT

A cargo transportation, transfer and delivery method and system is disclosed where the primary distances traveled by the cargo in a cargo carrying vehicle, called a ‘transporter’ need not stop to load or unload cargo. The transporter is designed to hold cargo in standardized cargo containers that have been designed to hold a multitude of package or product sizes, types, and weights. These containers are further designed with a motion control and constraining system to aid in the reliable transfer and holding of the cargo containers within the transporter and when being transferred onto and off of the transporter. The containers are further designed to be readily and reliably moved by a cargo transfer system which moves containers on to and off of the transporter. The transporter travels through a tubular passage that may be above ground or below ground allowing it to bypass and otherwise avoid roads which are subject to many traffic starts and stops.

### CROSS-REFERENCE TO RELATED APPLICATION

This patent application claims the benefit of U.S. Provisional Patent Application Ser. Nos. 63/358,032 and 63/358,077, both entitled “Automated High-Speed Transporter,” both filed Jul. 1, 2022], which applications are incorporated in their entirety here by this reference.

### TECHNICAL FIELD

The subject of this patent application relates generally to cargo transport, transfer, and delivery methods and more particularly, but not by way of limitation, to transportation infrastructure facilitated by autonomous vehicles and autonomous handling systems.

### BACKGROUND

Automation has been incorporated into many facets of our lives and infrastructure. However, the banal task of transporting and delivering cargo, materials and more generally, goods has remained a process which is laborious and incorporates vast amounts of manual handling, sorting, loading, unloading, pickup and delivery. Indeed, doorstep delivery has not changed much in the last 100 years and still requires a person, usually on a delivery truck to stop the truck, locate a package and then carry that package to the destination doorstep. For doorstep package pickup these steps are reversed and again are extremely laborious. This process may be repeated any number of times depending on the number of packages to be delivered or stops being made. Moreover, delivery vehicles can make hundreds of physical starts and stops while in traffic or for traffic lights or signs or even weather. This stop and start or even slowing and speeding of hundreds or even thousands of pounds of cargo is extremely inefficient and the horsepower to accelerate a load is many times more than the horsepower required to maintain a load at constant speed. These inefficiencies of starts and stops are dramatically reduced in transportation systems such as train on a rail system or ocean freighter but in the final mile of cargo delivery, these inefficiencies are dramatically increased. To compound this difficulty, packages can be of almost any size, shape, and weight with each requiring separate and sometimes special handling.

Thus, there is a need for a method and system which can transport cargo on an autonomous vehicle which does not require stopping during transport of cargo to either load or unload cargo.

### SUMMARY

The novel features which are characteristics of this disclosure, both as to structure and method of operation thereof, together with further aims and advantages thereof, will be understood from the following summary, considered in connection with the accompanying drawings. In which embodiments of the disclosure are illustrated by way of example. It is to be expressly understood, however, that the drawings are for the purpose of illustration and description only, and they are not intended as a definition of the limits of the disclosure.

This disclosure describes a method for autonomously transferring cargo from one vehicle to another while both vehicles are in motion by providing a first autonomous vehicle, sometimes referred to as a transporter. The transporter has a first cargo area configured to carry a cargo container and travels at a first speed along a first path. There is also a second autonomous vehicle, sometimes referred to as a sled. The sled has a second cargo area configured to carry the cargo container, with the sled configured to accelerate, decelerate, and travel at a second speed along a second path. The path may be a rail system either above ground, or below it may be a magnetic levitation system either above ground or below, and/or it may be a pneumatic hovering system above ground or below. The path may be any means or method of restriction along any axis to guide either the transporter and or the sled along a path. The means of propulsion of one or both or any number of vehicles may be electrical, electromechanical, pneumatic, an ion drive, jet propulsion, rocket propulsion or any method which would adequately provide locomotion to the transporter and or the sled or any number or type of vehicles. The cargo areas may have many methods or means of guiding and restraining cargo containers within or on them, such as magnetic levitation or magnetic locking, pneumatic levitation or pneumatic locking, wheeled motion or the locking of wheels, robotic arms, hooks, clamps, straps or the like or any type of motion control system or any means of motion restriction and or restriction of motion along any axis as is necessary to accomplish the task of moving and securing cargo containers on one or both vehicles or any number of vehicles. The next step is autonomously loading the cargo container within the sled cargo area. This again can be accomplished by any motion means heretofore described. The loading of the sled may be done by another vehicle autonomously or it may be done by another mechanism autonomously. There may be another mechanism which conveys cargo containers from a user to the sled. This mechanism is sometimes referred to as a kiosk. Once the cargo container is loaded within or on to the sled, the sled computing means, or other computing means will determine the best time to begin acceleration and what that acceleration rate should be by receiving information of the transporter's position and speed and by computing a cargo transfer location solution. This information may be received directly from the transporter to the sled, or it may be sent to an intermediate location where it may be processed by a computing means. This information may be processed at an intermediate location with computing means and a cargo transfer solution sent to the sled or the sled may take the information and compute its own target transfer location solution. The cargo transfer location solution brings the sled into proximity to the transporter such that their respective cargo areas are aligned such that cargo containers may be transferred from the sled to the transporter or from the transporter to the sled or to and from any desired vehicle or location. The cargo transfer location solution may be calculated by the transporter, by the sled, or it may be calculated at any location with appropriate computing means to arrive at a solution and then transmitted to either the transporter or sled. That cargo transfer location solution, independent of where it was calculated, may be transmitted to the sled, the transporter, or any vehicle necessary to affect the moving of cargo containers for the purpose of cargo transfer. Once a cargo transfer location solution has been computed, the sled may be accelerated, based on the cargo transfer location solution. As the sled approaches the transporter the cargo transfer location solution may require updating, by receiving additional information of the transporter's position and speed and comparing it to the sled's position and speed and changing the sled's position, by way of velocity modulation. Where velocity modulation is understood to mean any combination of acceleration, deceleration, or constant velocity between two vehicles in order to move relative location/s between the transporter and sled or any other vehicle or to fix relative location/s between the transporter and sled or any other vehicle. This relative location may be based on the alignment of the transporter and the sled cargo holding areas and or systems whether the system is a dovetail rail system or any cargo guiding or restraining system. The velocity of either the transporter or the sled may be modulated to accomplish positioning or alignment. Once in alignment, a cargo container may be transferred autonomously from the sled to the transporter and/or from the transporter to the sled. A cargo container on the transporter may be repositioned by first loading it onto the sled, the sled may modulate its velocity such that a new position between the sled and the transporter is established and the cargo may then be transfer from the sled back to the transporter. In this repositioning scenario, either the speed and hence position of the sled may be modulated or the speed and hence position of the transporter may be modulated.

### BRIEF DESCRIPTION OF THE DRAWINGS

The novel features which are characteristic of the systems, both as to structure and method of operation thereof, together with further aims and advantages thereof, will be understood from the following description, considered in connection with the accompanying drawings, in which embodiments of the system are illustrated by way of example. It is to be expressly understood, however, that the drawings are for the purpose of illustration and description only, and they are not intended as a definition of the limits of the system. For a more complete understanding of the disclosure, as well as other aims and further features thereof, reference may be had to the following detailed description of the disclosure in conjunction with the following exemplary and non-limiting drawings wherein:

FIG. 1 is an exemplary isometric view of a transporter with containers traveling on a rail system extending into and out of a tubular structure in accordance with embodiments of the present disclosure;

FIG. 2 is an exemplary isometric view of a transporter with a sled beginning to travel beside the transporter in accordance with embodiments of the present disclosure;

FIG. 3 is an exemplary isometric view of a transporter with a sled traveling in proximity to and matching the speed of the transporter in accordance with embodiments of the present disclosure;

FIG. 4 is an exemplary top view of a transporter with a sled vehicle traveling in proximity to and matching the speed of the transporter with the motion constraining systems aligned in accordance with embodiments of the present disclosure;

FIG. 5 is an exemplary isometric view of a transporter vehicle with a sled vehicle traveling in proximity to and matching the speed of a transporter vehicle with the motion constraining systems aligned in accordance with embodiments of the present disclosure;

FIG. 6 is an exemplary isometric view of a transporter traveling in proximity to and matching the speed of a sled and with a cargo container being automatically moved from the sled to the transporter in accordance with embodiments of the present disclosure;

FIG. 7 is an exemplary isometric view of a transporter having received and secured a cargo container transferred from a sled and the sled decelerating while the transporter continues to travel at speed in accordance with embodiments of the present disclosure;

FIG. 8 is an exemplary isometric view of a sled carrying a container approaching a kiosk system in accordance with embodiments of the present disclosure;

FIG. 9 is an exemplary isometric view of a sled carrying a container stopping and positioning itself at a kiosk system in order to transfer the container to the kiosk in accordance with embodiments of the present disclosure;

FIG. 10 is an exemplary isometric view of a container being autonomously transferred to a kiosk system, with side walls removed on the kiosk, in accordance with embodiments of the present disclosure;

FIG. 11 is an exemplary isometric view of a container being conveyed by an elevator to a kiosk send and receive platform in accordance with embodiments of the present disclosure;

FIG. 12 is an exemplary isometric view of a container being autonomously dispensed to a kiosk send and receive platform in accordance with embodiments of the present disclosure;

FIG. 13 is an exemplary schematic view of a transporter and a sled and their respective distance and velocity graphs in accordance with embodiments of the present disclosure;

FIG. 14 is an exemplary schematic view of a transporter and a sled and their respective distance and velocity graphs showing the sled matching the speed of the transporter in accordance with embodiments of the present disclosure;

FIG. 15 is an exemplary schematic view of a transporter and a sled and their respective distance and velocity graphs showing the sled, having matched the speed of the transporter and the transporter having transferred containers to the sled in accordance with embodiments of the present disclosure;

FIG. 16 is an exemplary schematic view of a transporter and a sled and their respective distance and velocity graphs showing the sled decelerate with containers while the transporter continues to travel at speed in accordance with embodiments of the present disclosure;

FIG. 17 is an exemplary schematic view of a sled, having stopped at a kiosk, transferring a container to the kiosk in accordance with embodiments of the present disclosure;

FIG. 18 is an exemplary schematic view of a sled stopped at a kiosk that has a container ready to be transferred to the sled with an approaching transporter in accordance with embodiments of the present disclosure;

FIG. 19 is an exemplary schematic view of a sled, having stopped at a kiosk, receiving a container and with an approaching transporter in accordance with embodiments of the present disclosure;

FIG. 20 is an exemplary schematic view of a sled accelerating to match the speed of a transporter in accordance with embodiments of the present disclosure;

FIG. 21 is an exemplary schematic view of a sled having matched the speed of a transporter and transferring a container to the transporter in accordance with embodiments of the present disclosure;

FIG. 22 is an exemplary schematic view of a sled having transferred a container to a transporter, decelerating while the transporter continues at speed in accordance with embodiments of the present disclosure;

FIG. 23 is an exemplary schematic view of a container being transferred from a transporter to a sled so that it may be repositioned on the transporter in accordance with embodiments of the present disclosure;

FIG. 24 is an exemplary schematic view of a sled accelerating to a new position on a transporter so that a container may be repositioned to a forward position on the transporter in accordance with embodiments of the present disclosure;

FIG. 25 is an exemplary schematic view of a container being transferred to a sled so that the container may be repositioned on the transporter in accordance with embodiments of the present disclosure;

FIG. 26 is an exemplary schematic view of a sled decelerated to a new position on a transporter so that a container may be repositioned to a rearward position on the transporter in accordance with embodiments of the present disclosure;

FIG. 27 is an exemplary schematic view of a transporter loop with 2 sled and kiosk locations in accordance with embodiments of the present disclosure;

FIG. 28 is an exemplary schematic view of 2 transporter loops and 2 transporters traveling in proximity of each other to exchange containers in accordance with embodiments of the present disclosure;

FIG. 29 is an exemplary isometric view of container transfer system 115 in accordance with embodiments of the present disclosure;

FIG. 30 is an exemplary orthogonal top view of container transfer system 115 in accordance with embodiments of the present disclosure;

FIG. 31 is an exemplary isometric view of motion control system 305 in accordance with embodiments of the present disclosure;

FIG. 32 is an exemplary orthogonal bottom view of motion control system 305 in accordance with embodiments of the present disclosure;

FIG. 33 is an exemplary orthogonal top view of motion control system 305 in accordance with embodiments of the present disclosure;

FIG. 34 is an exemplary orthogonal end view of motion control system 305 in accordance with embodiments of the present disclosure;

FIG. 35 is an exemplary orthogonal top section view of motion control system 305 in accordance with embodiments of the present disclosure;

FIG. 36 is an exemplary orthogonal end view of motion control system 305 showing gear train in accordance with embodiments of the present disclosure;

FIG. 37 is an exemplary partial orthogonal section view of motion control system 305 in extend position in accordance with embodiments of the present disclosure;

FIG. 38 is an exemplary partial orthogonal section view of motion control system 305 in retract position in accordance with embodiments of the present disclosure;

FIG. 39 is an exemplary partial isometric section view of motion control system 305 in accordance with embodiments of the present disclosure;

FIG. 40 is an exemplary orthogonal front view of braking system 303 in accordance with embodiments of the present disclosure;

FIG. 41 is an exemplary orthogonal side view of braking system 303 in accordance with embodiments of the present disclosure;

FIG. 42 is an exemplary isometric view of braking system 303 in accordance with embodiments of the present disclosure;

FIG. 43 is an exemplary orthogonal front view of container 452 in accordance with embodiments of the present disclosure;

FIG. 44 is an exemplary orthogonal side view of container 452 in accordance with embodiments of the present disclosure;

FIG. 45 is an exemplary orthogonal bottom view of container 452 in accordance with embodiments of the present disclosure;

FIG. 46 is an exemplary orthogonal side section view of container 452 in accordance with embodiments of the present disclosure;

FIG. 47 is an exemplary isometric top view of container 452 in accordance with embodiments of the present disclosure;

FIG. 48 is an exemplary isometric bottom view of container 452 in accordance with embodiments of the present disclosure;

FIG. 49 is an exemplary isometric view of dovetail rail 481 in accordance with embodiments of the present disclosure;

FIG. 50 is an exemplary orthogonal end view of dovetail rail 481 in accordance with embodiments of the present disclosure;

FIG. 51 is an exemplary orthogonal top view of dovetail rail 481 in accordance with embodiments of the present disclosure;

FIG. 52 is an exemplary orthogonal side view of dovetail rail 481 in accordance with embodiments of the present disclosure;

FIG. 53 is an exemplary orthogonal bottom view of dovetail rail 481 in accordance with embodiments of the present disclosure;

FIG. 54 is an exemplary isometric side view of a container within a transporter 108 and showing portions of container transfer system 115 in accordance with embodiments of the present disclosure;

FIG. 55 is an exemplary orthogonal side view of a container within a transporter 108 and showing dovetail interface in accordance with embodiments of the present disclosure;

FIG. 56 is an exemplary orthogonal side view of a container within a transporter 108 in accordance with embodiments of the present disclosure;

FIG. 57 is an exemplary orthogonal side section view of a container being transferred within a transporter 108 in accordance with embodiments of the present disclosure;

FIG. 58 is an exemplary orthogonal top view of a container being transferred from a transporter 108 to a sled 156 in accordance with embodiments of the present disclosure;

FIG. 59 is an exemplary orthogonal side section view of a container being transferred from a transporter 108 to a sled 156 in accordance with embodiments of the present disclosure;

FIG. 60 is an exemplary isometric side section view of a container being transferred from a transporter 108 to a sled 156 in accordance with embodiments of the present disclosure;

FIG. 61 is an exemplary orthogonal side view of a transporter 108 with metal covers removed and showing feature details accordance with embodiments of the present disclosure;

FIG. 62 is an exemplary isometric top view of transporter 108 with metal covers removed and showing feature details accordance with embodiments of the present disclosure;

FIG. 63 is an exemplary isometric bottom view of transporter 108 with metal covers removed and showing feature details accordance with embodiments of the present disclosure;

FIG. 64 is an exemplary isometric top view of sled 156 with metal covers removed and showing feature details accordance with embodiments of the present disclosure;

FIG. 65 is an exemplary isometric bottom view of sled 156 with metal covers removed and showing feature details accordance with embodiments of the present disclosure;

FIG. 66 is an exemplary isometric view of container transfer kiosk 170 in accordance with embodiments of the present disclosure;

FIG. 67 is another exemplary isometric view of container transfer kiosk 170 in accordance with embodiments of the present disclosure;

FIG. 68 is another exemplary isometric view of container transfer kiosk 170 in accordance with embodiments of the present disclosure;

FIG. 69 is an exemplary isometric view of container transfer kiosk 170 having received large container 116 in accordance with embodiments of the present disclosure;

FIG. 70 is an exemplary isometric view of container transfer kiosk 170 having moved large container 116 up with elevator platform 610 in accordance with embodiments of the present disclosure;

FIG. 71 is an exemplary isometric view of container transfer kiosk 170 having moved large container 116 onto kiosk send and receive platform 183 in accordance with embodiments of the present disclosure;

FIG. 72 is an exemplary orthogonal side view of container transfer kiosk 170 having moved large container 116 onto kiosk send and receive platform 183 in accordance with embodiments of the present disclosure;

FIG. 73 is an exemplary isometric bottom view of container transfer kiosk 170 and associated motion control in accordance with embodiments of the present disclosure; and

FIG. 74 is a flow chart for an example cargo transfer control loop.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The disclosed solution describes a cargo transportation, transfer and delivery method and system where the primary distances traveled by the cargo in a cargo carrying vehicle, called a ‘transporter’ need not stop to load or unload cargo. The transporter is designed to hold cargo in standardized cargo containers that have been designed to hold a multitude of package or product sizes, types, and weights. These containers are further designed with a motion control and constraining system to aid in the reliable transfer and holding of the cargo containers within the transporter and when being transferred onto and off of the transporter. The containers are further designed to be readily and reliably moved by a cargo transfer system which moves containers on to and off of the transporter. The transporter travels through a tubular passage that may be above ground or below ground allowing it to bypass and otherwise avoid roads which are subject to many traffic starts and stops.

The transporter is designed to remain in motion when carrying cargo and when loading or unloading cargo, thereby saving vast amounts of energy and time as the amount of energy required to accelerate a load is significantly greater than the energy required to maintain motion. This is accomplished by having an auxiliary vehicle called a ‘sled’ which carries cargo containers from a stationary position to a speed which matches that of the transporter, by calculating a cargo transfer location solution based on the known speed and position of the transporter. Once the speed of the transporter is matched, the sled maneuvers into proximity of the transporter and aligns the motion control and constraining system of both the sled and that of the transporter by accelerating or decelerating the sled and then matching the speed of the transporter so that containers may be readily transferred from the sled to the transporter or from the transporter to the sled with the aid of a container transfer system which may be on one or both vehicles. Once cargo is transferred to the desired location on either the sled or the transporter, it may be secured with a further braking system. Cargo transferred from the transporter to the sled may be decelerated to a stationary position for autonomous unloading of the cargo.

Containers may be loaded onto the sled by first having a person place a container, usually filled with goods or a product, onto a container conveyance system called a ‘kiosk’. This kiosk may be accessed by either a control interface on the kiosk itself or through a software application which allows communication with the kiosk, sled, and transporter or collectively the ‘transportation system’ as a whole. The kiosk, also having a motion control and constraining system onto which the container is slid, conveys the container to the sled and then transfers the container from the kiosk to the sled's cargo area and motion control and constraining system using a container transfer system. Once the container is secured onto the sled by way of a braking system, the sled is ready to be accelerated to meet and transfer its container to the moving transporter. Conversely, the sled may receive a container from the transporter and deliver it to a kiosk, which conveys the container up to a person receiving the container.

FIG. 1 shows an example embodiment of a vehicle also called a transporter, 108. The transporter 108 rides on an upper rail, 104 and a lower rail, 132 by way of upper front wheel, 110, drive wheel, 128, upper rear wheel, 118 and lower rear wheel 122. Transporter 108 receives electric power transmitted through upper rail 104 and lower rail 132 by way of upper brush contact 112 and lower brush contact 126. The transporter 108 has a cargo area 113 suitable to hold various sizes and types of containers such as small container 114 or large container 116. The small container 114 and large container 116 are only representative containers and may have any size or configuration, they may have machine readable identification which may contain information concerning the cargo contents, destination, special handling, or any information relevant to either the container or its contents or they may have means of transmitting such information. The containers may have environmental control both active or passive and they may have various sensors to monitor any state of the contents or of the container. The upper rail 104 is supported by upper rail holding structure 106 at several points while the lower rail 132 is supported by lower rail holding structure 130. In each of the holding structures at least some portion of the structure is an electrical insulator to prevent the electrically energized upper rail 104 and the electrically energized lower rail 132 from shorting to ground when undesired. Upper rail 104 and lower rail 132 extend into and out of tubular passage 102. Tubular passage 102 may be constructed of any suitable material. In this example, transporter 108 has forward motion 103. Also, in this example the entire aforementioned assembly of FIG. 1 is supported by support structure 124. However, the entire assembly of FIG. 1 may be underground without support structure 124 or above ground with many variants of support structure 124. Additionally, while transporter 108 is shown on a rail system it may just as easily have the same functionality with a magnetic levitation system or any type of system to provide forward locomotion while directing transporter 108 on a desired path.

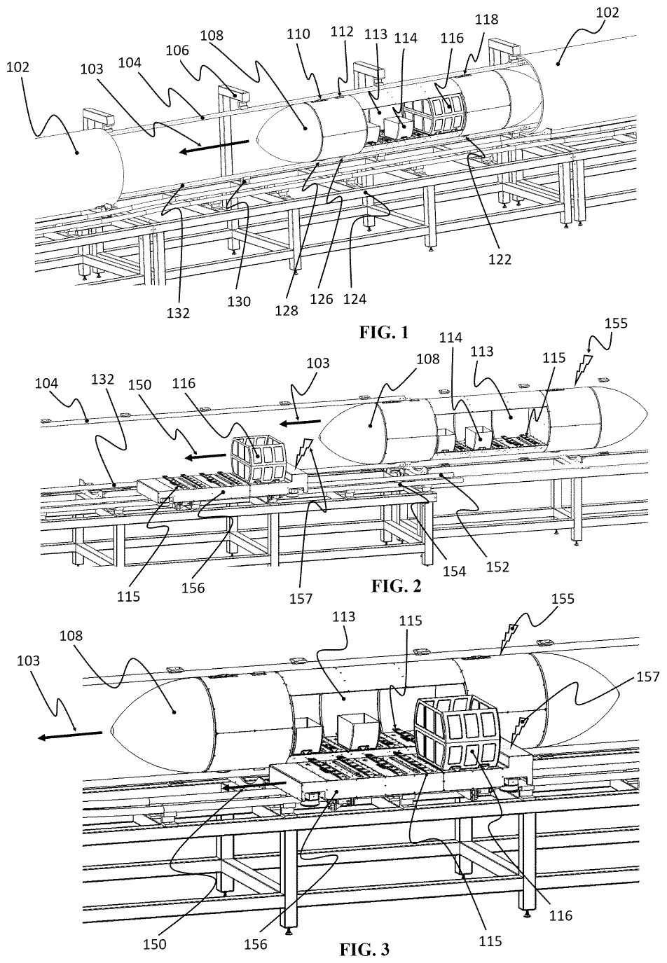

FIG. 2 shows an example embodiment of the transporter 108 of FIG. 1 and a vehicle also called a sled 156. The sled in this example is carrying large container 116 and is moving in forward motion 150 on electrified inner rail 152 and electrified outer rail 154. Large container 116 is secured into position by a container transfer system 115 for sled 156. Likewise, small container 114 is secured into position by container transfer system 115 for transporter 108. Collectively, large container 116 and small container 114 may be called containers or cargo containers. As transporter 108 travels toward sled 156, sled 156 is initially in a stationary position. By sending a transmit signal 155 which contains speed, direction and position data and any other relevant data of the transporter 108 to sled 156 which receives transmit signal 155 in the form of a receive signal 157 a cargo transfer location solution may be calculated by the sled. The cargo transfer location solution having necessary timing, acceleration, and speed information in order to accelerate sled 156 in the direction of transporter 108 and have sled 156 come into proximity of transporter 108 such that cargo containers may be readily transferred from sled 156 to transporter 108 or from transporter 108 to sled 156. Signal 155 may alternatively be sent to another location and in turn be sent to sled 156. Sled 156, having received this information may calculate the necessary cargo transfer location solution, which would be combined as forward motion 15, to have sled 156 be parallel to and in proximity of cargo area 113 so that large container 116 may be transferred from sled 156 to transporter 108. Calculation of necessary cargo transfer location solution may alternatively be calculated by the transporter or by a processing computer or computing means located at another location and then the cargo transfer location solution may be transmitted to sled 156. Information and by extension signal 155 containing position, speed, direction or any relevant information of transporter 108 may be generated by any of a number of methods or means including but not limited to radar, lidar, image recognition, sonar optical encoders, magnetic encoders, electrical switches, magnetic switches, optical switches or any appropriate method or means of deriving transporter 108 or sled 156 location, speed, direction, or any relevant state information of transporter 108 or sled 156.

FIG. 3 shows an example embodiment of sled 156 paralleling transporter 108 with forward motion 103 being matched by cargo transfer location solution with forward motion 150 and container transfer system 155 for sled 156 matching the location of transporter 108 container transfer system 115. Final detailed adjustments to position and velocity of sled 156 may be made from position, speed and direction data received by transmit signal 155 which when arriving at sled 156, is receive signal 157. These detailed adjustments of the updating of the cargo transfer location solution are being used to align sled 156 container transfer system 115 to transporter 108 container transfer system 115.

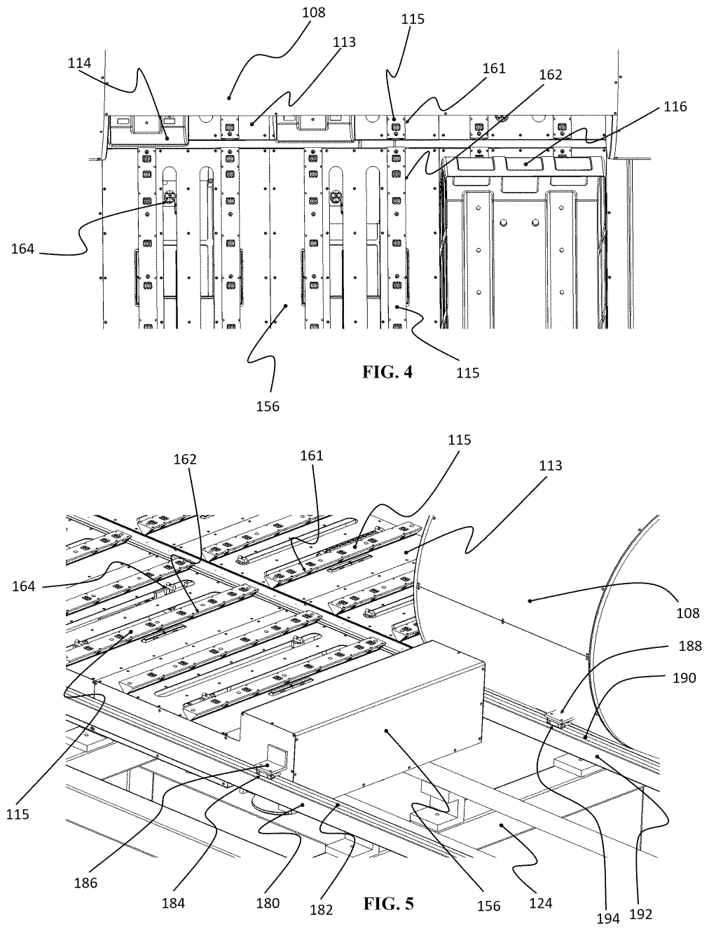

FIG. 4 shows an example embodiment of the cargo areas of transporter 108 and sled 156 with transporter 108 container transfer system 115 aligning with sled 156 container transfer system 115. This alignment is exemplified by transporter container transfer system edge 161 aligning with sled container transfer system edge 162, although any convenient edge surface or artifact may be used to demonstrate or otherwise show alignment or accomplish alignment. Sufficient alignment is attained in order to allow large container 116 to be transferred from sled 156 to transporter 108. Alignment may be attained by updating the cargo transfer location solution and adjusting the location of sled 156 relative to transporter 108 through acceleration and deceleration of the sled 156 relative to the transporter 108 and position of the sled 156 to transporter 108 may be held by matching the speed of the sled 156 to the speed of the transporter 108. Alternatively, alignment may be attained by updating the cargo transfer location solution and adjusting the location of transporter 108 relative to sled 156 through acceleration and deceleration of the transporter 108 relative to the sled 156 and position of the transporter 108 to sled 156 may be held by matching the speed of the transporter 108 to the speed of the sled 156.

FIG. 5 shows an example embodiment of another method of alignment by way of adjusting cargo transfer location solution during travel of transporter 108 and sled 156. In this example transporter encoder scale holder 192 is used with transporter encoder scale 190 affixed to it and the assembly is affixed to a stationary structure, in this case support structure 124. Transporter read head 194 is placed above transporter encoder scale 190 and is held in place with transporter read head mount 188. As transporter 108 moves, its exact position relative to transporter encoder scale 190 is known through interaction with transporter read head 194. Likewise, sled encoder scale holder 180 is affixed to support structure 124 and sled encoder scale 190 is affixed to it. Sled encoder read head 184 is placed above sled encoder scale 182 and affixed to sled 156 by way of sled read head mount 186. As sled 156 moves, its exact position relative to sled encoder scale 182 is known through interaction with sled read head 184. Transporter encoder scale 190 is aligned to sled encoder scale 182 so that sled container transfer system edge 162 is aligned with transporter container transfer system edge 161 when sled encoder read head 184 is at the same location or correlated position as transporter encoder read head 194. Any fixed offset between the read heads may be introduced and the same task of alignment may be accomplished by accommodating that offset. Additionally, any of the several transporter 108 container transfer systems 115 rails may be aligned to any other sled 156 container transfer system 115 rails so as to put containers in any desired location. The encoder mechanism shown in this example may be optical, magnetic or any other appropriate distance measurement method or system such as GPS or the like. The data from the transporter encoder read head 194 may be transmitted by transmit signal 155 and received by the sled 156 through receive signal 157, and a transmit signal can be sent from sled 156 to be received by transporter 108, thereby allowing each vehicle to know the position of the other and allow communication between the two vehicles.

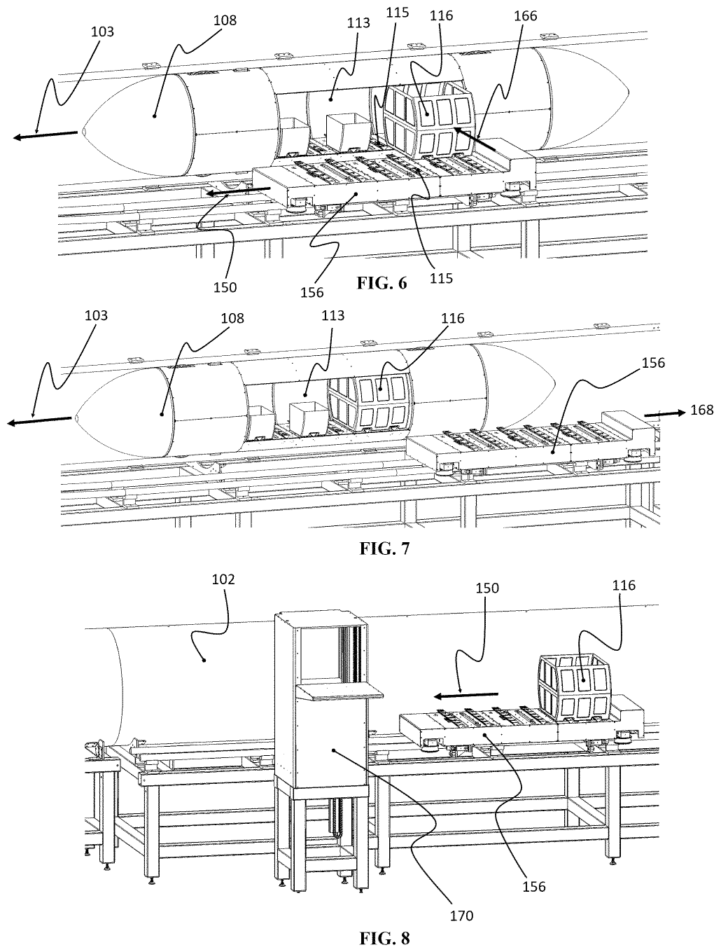

FIG. 6 shows an example embodiment of transporter 108 with forward motion 103 and sled 156 with forward motion 150 being equal and with transporter 108 container transfer system 115 sufficiently in alignment with sled 156 container transfer system 115 so that large container 116 may be transfer automatically into cargo area 113 with container transfer motion 1, 166 by automated means to be described in detail later in this disclosure.

FIG. 7 shows an example embodiment of large container 116 fully loaded into cargo area 113 of transporter 108 and continuing to move with forward motion 103, while sled 156 decelerates with sled deceleration 168.

FIG. 8 shows an example embodiment of, alternatively, a container using the steps above but in reverse, may be transferred from transporter 108 to sled 156. In this example of FIG. 8 large container 116 is secured to sled 156 and both have a forward motion 150. Sled 156 is approaching container transfer kiosk 170.

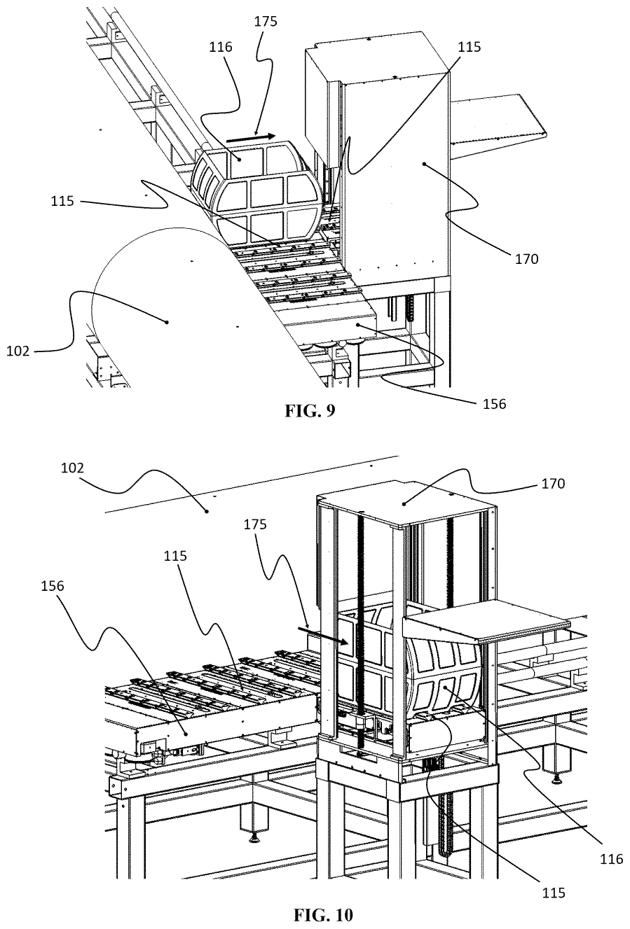

FIG. 9 shows an example embodiment of a sled 156, carrying large container 116 positioning itself in front of transfer kiosk 170 and aligning kiosk 170 container transfer system 115 with sled 156 container transfer system 115 so that large container 116 may be automatically transferred to transfer kiosk 170 with container transfer motion 2, 175. This automated motion to be more fully described later in this disclosure.

FIG. 10 shows an example embodiment of large container 116 fully loaded into container transfer kiosk 170 and onto kiosk 170 container transfer system 115 by way of automated container transfer motion 2, 175.

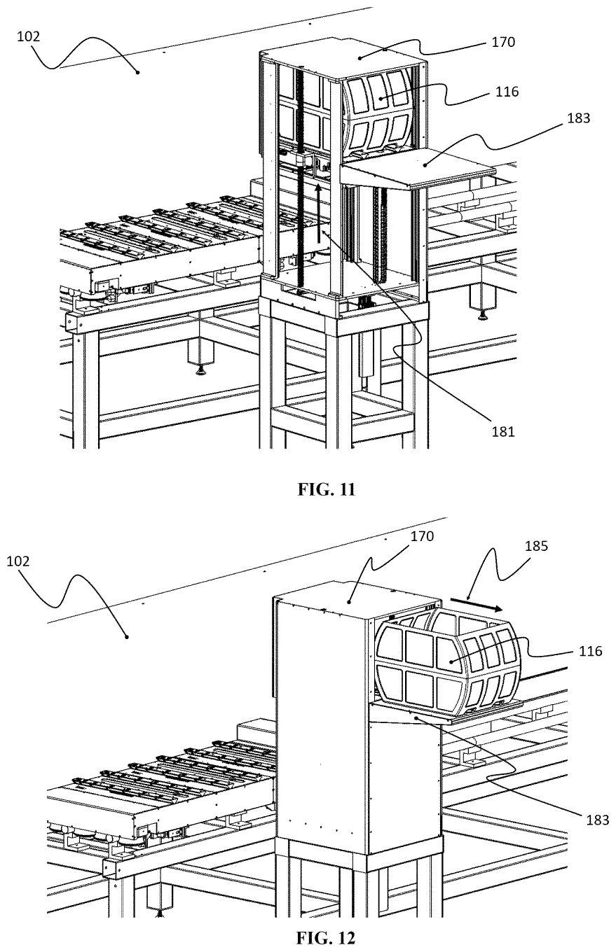

FIG. 11 shows an example embodiment of large container 116 being automatically conveyed up with kiosk elevator up motion 181. This automated motion to be more fully described later in this disclosure.

FIG. 12 shows an example embodiment of large container 116 being automatically transferred out of container transfer kiosk 170 and onto kiosk send and receive platform 183 with container transfer motion 3, 185. At this point, a person may pick up the container or access the containers contents.

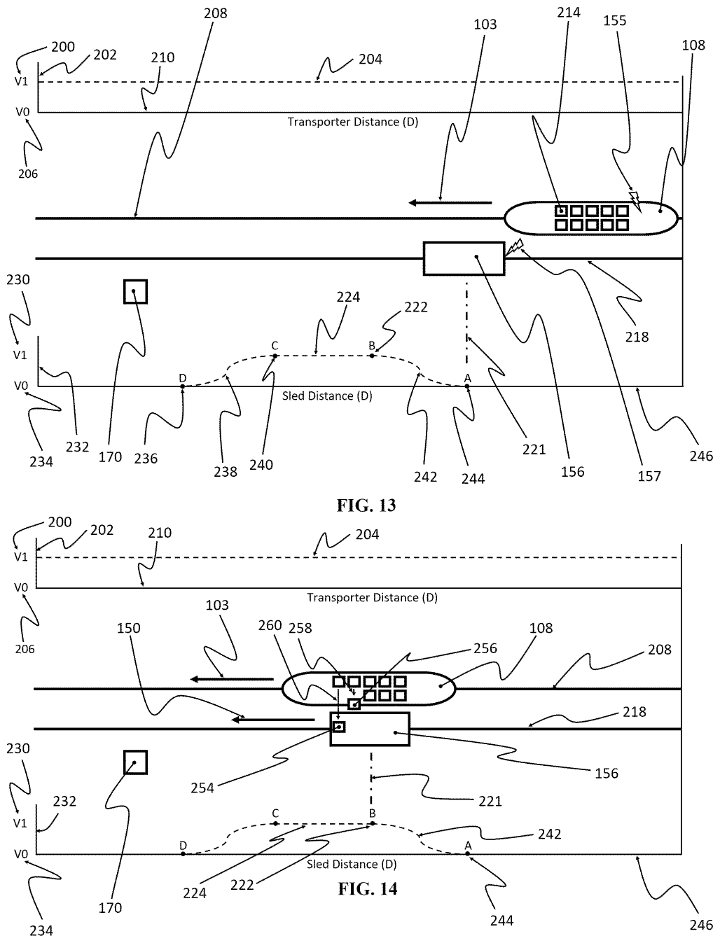

The following FIG. 13 through FIG. 17 shows the schematic steps in transferring a container from a moving transporter 108 to a moving sled 156 by accelerating the sled to the speed of the transporter so that the container may be transferred from the transporter 108 to the moving sled 156 then decelerating the moving sled so that the container may be transferred to a stationary kiosk 170.

FIG. 13 shows an example embodiment of a schematic of the heretofore disclosed cargo transport, transfer and delivery methods with a more detailed look at speed and distance of the transporter 108 and sled 156. Transporter 108 with containers 214 moves from right to left along path of transporter 208 with forward motion 103 and with velocity V1 of transporter 200. Looking at horizontal distance axis of transporter 210 and vertical velocity axis of the transporter 202, it can be seen that over the horizontal distance axis of transporter 210, the velocity line of the transporter 204 is substantially constant when referenced to velocity V0 of transporter 206. Adjacent to transporter 108 is sled 156 which is stationary. Looking at horizontal distance axis of sled 246 it can be seen that 2 points, position ‘A’ 244 start of acceleration and position ‘D’ 236 end of deceleration both have velocity V0 of sled. Looking at vertical velocity axis of sled 232, velocity V1 of the sled can be seen corresponding to points ‘B’ 222 and ‘D’ 236. In this example V1 of the transporter 108 and V1 of the sled 156 are equal. A line correlating sled position and velocity 221 is used for convenience of position and speed correlation of sled 156. As transporter 108 approaches sled 156 a transmit signal 155 is sent from transporter 108 to sled 156 giving position, speed, direction, and any other relevant information of transporter 108 in sufficient time to allow acceleration of sled 156 to reach velocity V1 of sled 230. Receive signal 157 having been received by sled 156, calculations are made by a computing means to create acceleration curve 242 so that velocity V1 of sled 230 can be attained in the time and distance available, given velocity V1 of transporter 200 so that cargo area of the transporter and cargo area of the sled come into proximity to one another so that cargo may be transferred.

FIG. 14 shows an example embodiment of sled 156 accelerating with forward motion 150 along path of sled 218 and along acceleration curve 242 from position ‘A’ start of acceleration 244 to position ‘B’ end of acceleration 222. At position ‘B’ end of acceleration 222 sled 156 has attained constant velocity 224 matching that of transporter 108. At this point containers 254 and 256 may be transferred along path of motion for transferred container 260 and path of motion for transferring container 258 respectively.

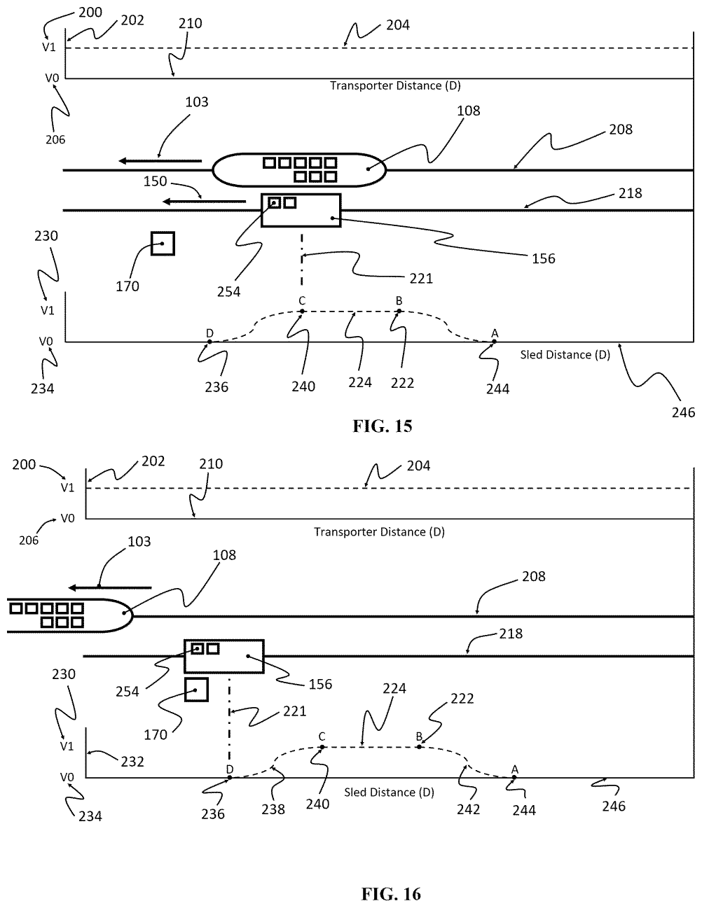

FIG. 15 shows an example embodiment of transporter 108 moving with forward motion 103 at velocity V1 200 of transporter 108 along path of transporter 208 and sled 156 paralleling and matching speed along path of sled 218 with forward motion 150. Transferred containers 254 having been transferred from transporter 108 to sled 156 during the distance traveled between position ‘B’ end of acceleration 222 and position ‘C’ start of deceleration 240 during which constant velocity 224 was maintained by sled 156. Sled 156 is moving toward container transfer kiosk 170 as well.

FIG. 16 shows an example embodiment of transporter 108 now moving away in forward motion 103 and sled 156 having decelerated along deceleration curve 238 comes to rest at position ‘D’ end of deceleration 236.

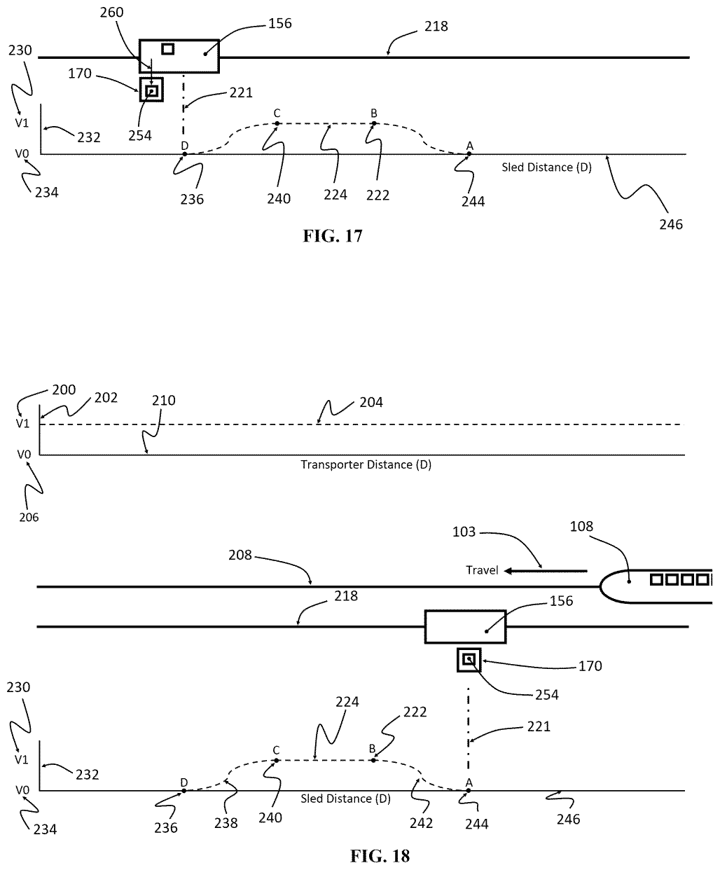

FIG. 17 shows an example embodiment of sled 156 having moved transferred container 254 to container transfer kiosk 170 along path of motion for transferred container 260 while sled 260 is stationary at position ‘D’ end of deceleration 236.

The following FIG. 18 through FIG. 22 shows the schematic steps in transferring a container from a stationary kiosk 170 to a stationary sled 156. The sled 156 then accelerates to match the speed of an oncoming transporter 108 and the sled transfers the container to the transporter. The transporter traveling on with the container while the sled comes to a stop.

FIG. 18 shows an example embodiment of transporter 156 stationary at position ‘A’ start of acceleration 244 with container transfer kiosk 170 containing transferred container 254 with transporter 108 moving at velocity V1 of transporter 200 in forward motion 103 and approaching sled 156.

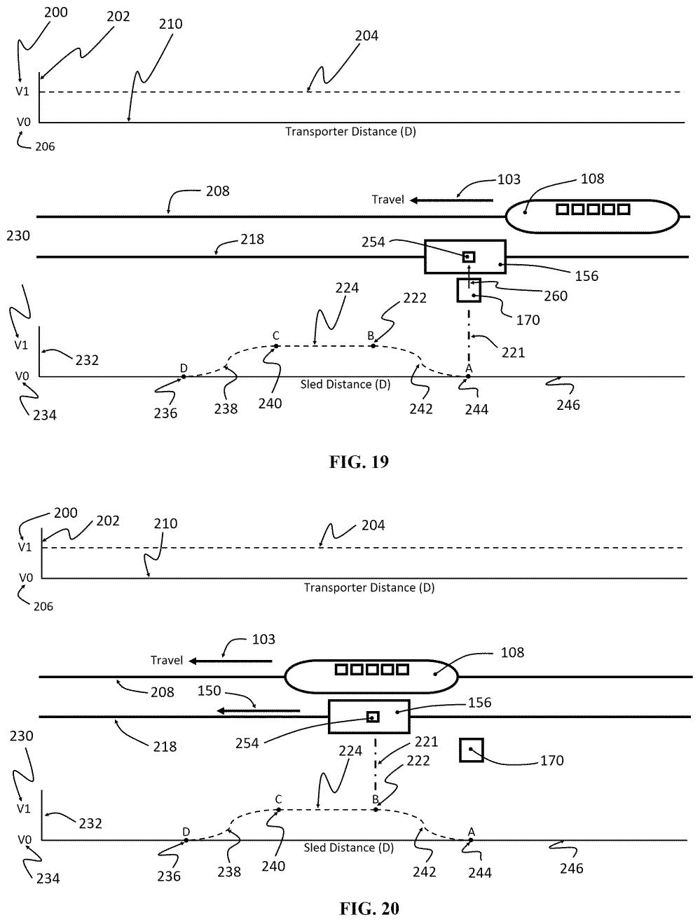

FIG. 19 shows an example embodiment of transferred container 254 having been loaded onto sled 156 from container transfer kiosk 170 along path of motion for transferred container 260 with transporter 108 approaching closer.

FIG. 20 shows an example embodiment of sled 156 containing transferred container 260 accelerating from position ‘A’ start of acceleration 244 to position ‘B’ end of acceleration 222 along acceleration curve 242 with forward motion 150 until sled 156 velocity V1 of sled 230 is equal to velocity V1 of transporter 200.

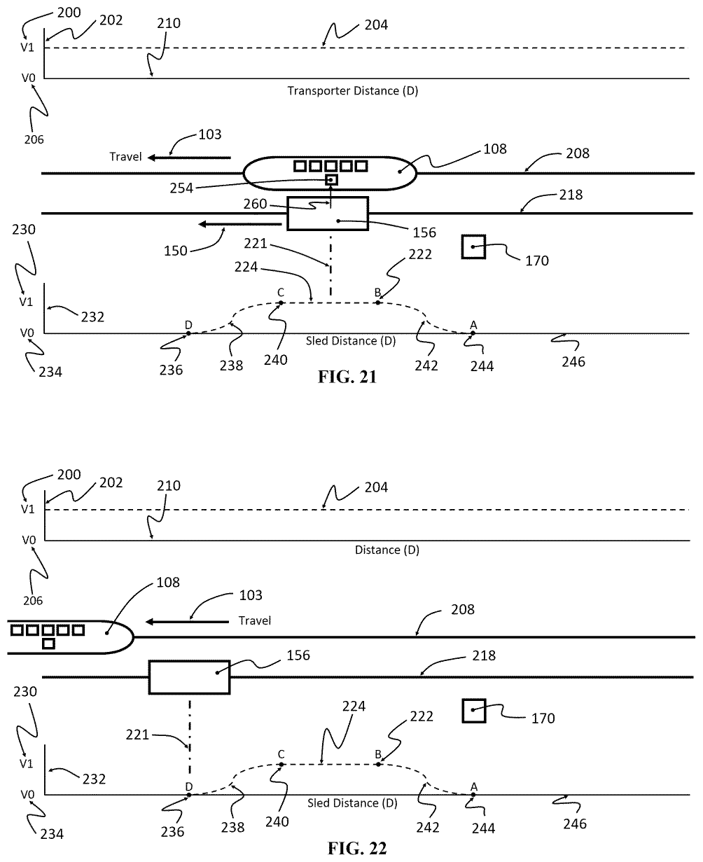

FIG. 21 shows an example embodiment of sled 156 having transferred container 254 to transporter 108 along path of motion for transferred container 260 while transporter 108 moves with forward motion 103 along path of transporter 208 at velocity V1 of transporter 200 and sled 156 moving with forward motion 150 along path of sled 218 at velocity V1 of sled 230. Velocity V1 of transporter 200 being equal to velocity V1 of sled 230.

FIG. 22 shows an example embodiment of transporter 108 continuing to travel along part of transporter 208 with forward motion 103 after having received transferred container 254. Sled 156 after having transferred container 254, decelerates to a stop from position ‘C’ start of deceleration 240 to position ‘D’ end of deceleration 236 along deceleration curve 238.

The following FIG. 23 through FIG. 26 shows the schematic steps of rearranging containers on transporter, 108 by way of transferring containers to sled 156 and either accelerating or decelerating sled 156 and transferring containers back onto transporter 108 with containers in new positions. This process may be used to make space for new containers or simply to position containers for transfer to another sled at a next station or for any purpose where the rearrangement of containers on transporter 108 would be beneficial.

FIG. 23 shows an example embodiment of sled 156 having accelerated along acceleration curve 242, now traveling at velocity V1 of sled 230 and matching velocity V1 of transporter 200 and transporter 108 having transferred container 254 from a central location on transporter 108 along path of motion for transferred container 260 to sled 156.

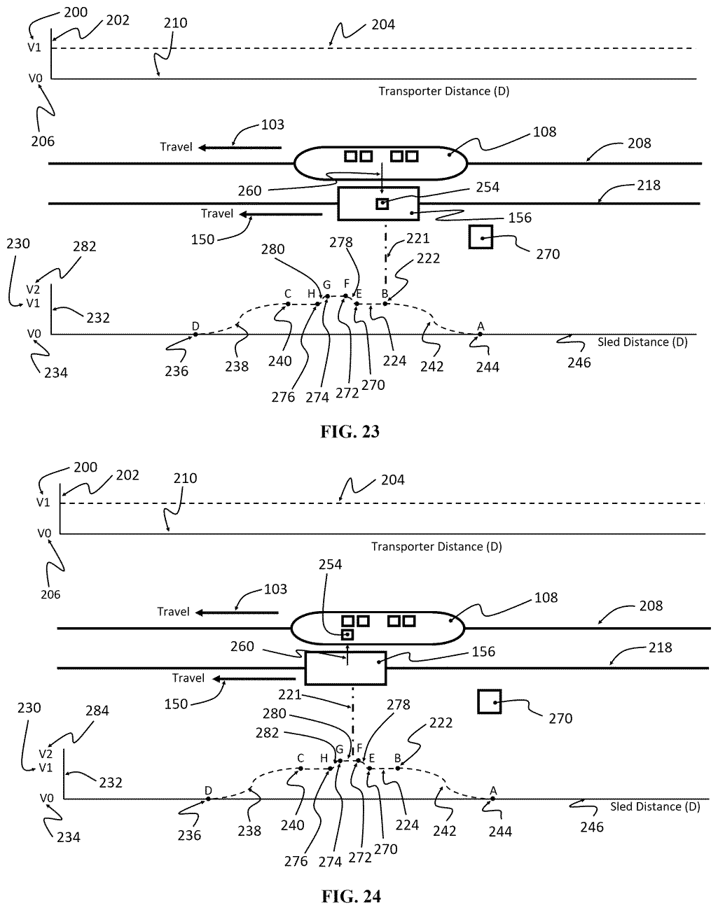

FIG. 24 shows an example embodiment of sled 156 having received transferred container 254 now accelerates from position ‘E’ start of repositioning acceleration 270 to position ‘F’ end of repositioning acceleration 272 along repositioning acceleration curve 278 and reaching constant velocity area 280 where sled 156 has moved in forward direction 150 arriving at a new forward position of transporter 108. At this new position transferred container 254 is transferred from sled 156 to transporter 108 along path of motion for transferred container 260. Using this method, containers may be repositioned from the back portion of transporter 108 to the front portion of transporter 108. Or any desired location in between.

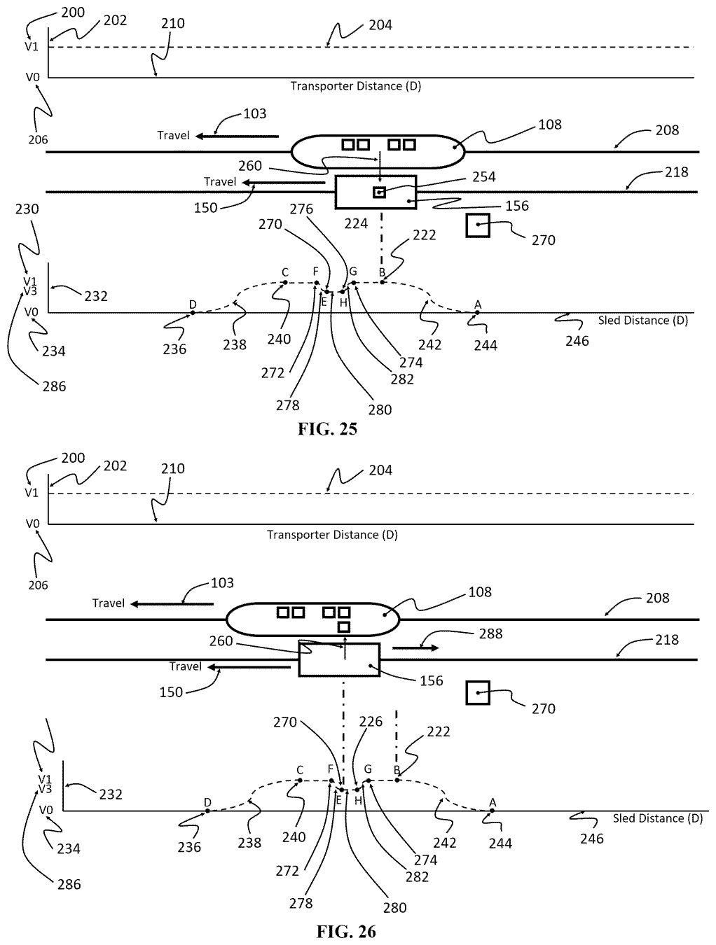

FIG. 25 shows an example embodiment of sled 156 having accelerated along acceleration curve 242, now traveling at velocity V1 of sled 230 and matching velocity V1 of transporter 200 and transporter 108 having transferred container 254 from a central location on transporter 108 along path of motion for transferred container 260 to sled 156.

FIG. 26 shows an example embodiment of sled 156 having received having transferred container 254 now decelerates from position ‘G’ start of repositioning deceleration 274 to position ‘H’ end of repositioning deceleration 226 along repositioning deceleration curve 282 and reaching constant velocity area 280 where sled 156 has moved in a backward direction 288 arriving at a new rearward position of transporter 108. At this new position transferred container 254 is transferred from sled 156 to transporter 108 along path of motion for transferred container 260. Using this method, containers may be repositioned from the front portion of transporter 108 to the rear portion of transporter 108, or any desired location in between.

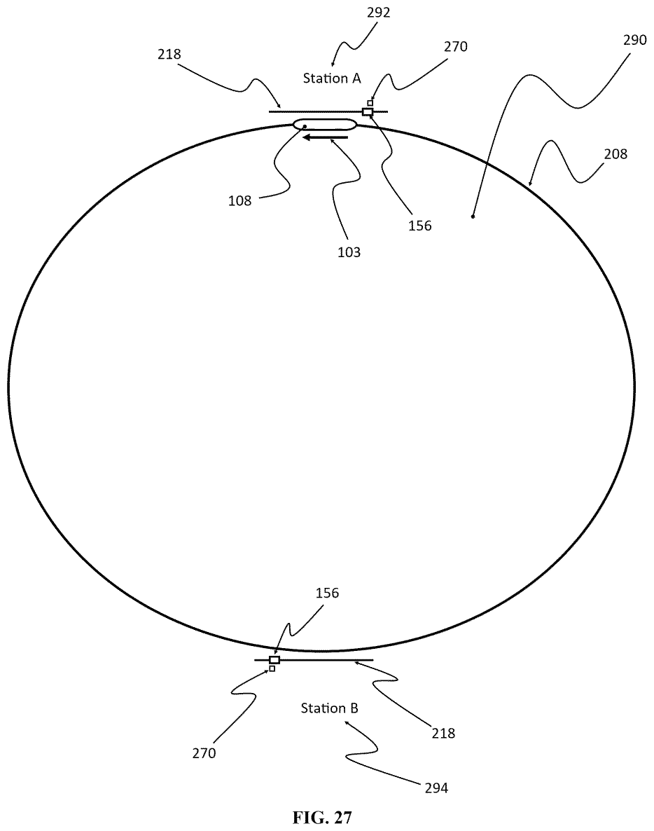

FIG. 27 shows an example embodiment of a first transportation loop 290 which is circular but may have any shape. Transportation loop 290 consists of at least two stations: a first station A, 292, and a second station B, 294, although it may have any number of stations beyond two. A station consists of at least a sled 156, a path of sled 218 and a kiosk 270. Containers may be onloaded at station A 292 and offloaded at station B 294 or onloaded at station B and offloaded at station A. Having a minimum of two stations creates a rudimentary ecosystem where goods may be transported from one location to another. This ecosystem may be expanded to millions of stations and there may be millions of such ecosystems each having a transportation loop 290.

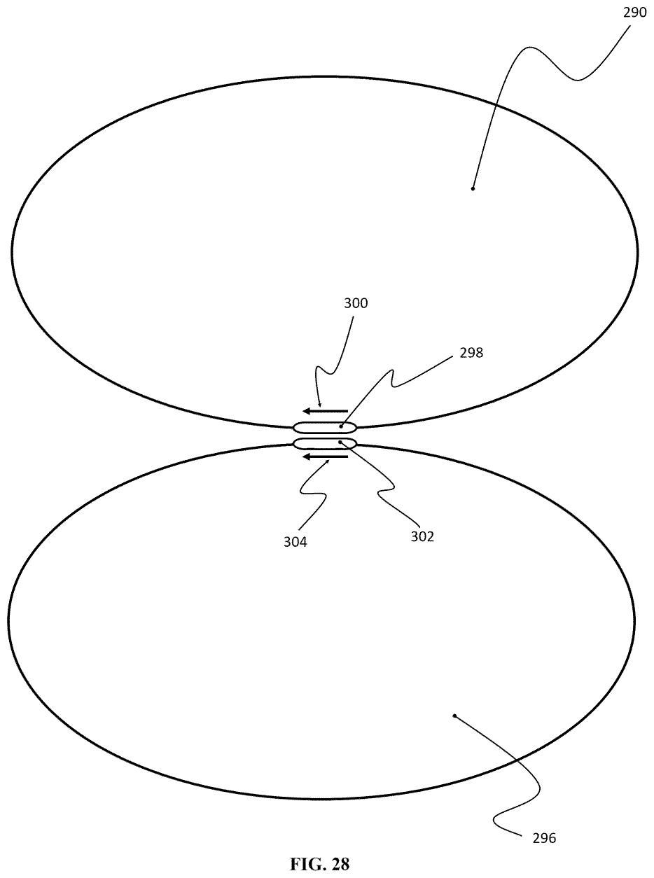

FIG. 28 shows an example embodiment of two transportation loops, a first transportation loop 290 and a second transportation loop 296. In this case, stations are not shown although it is understood that each transportation loop has at least 2 stations. A first transporter 298 traveling along first transporter direction of motion 300 is paralleled by a second transporter 302 and having second transporter direction of motion 304. In a manner that is substantially similar to that of a transporter 108 and sled 156, first transporter 298 and second transporter 302 may exchange or reorder containers. This method allows for the most efficient transfer of cargo where a first transporter 298 and a second transporter 302 need not stop to exchange cargo.

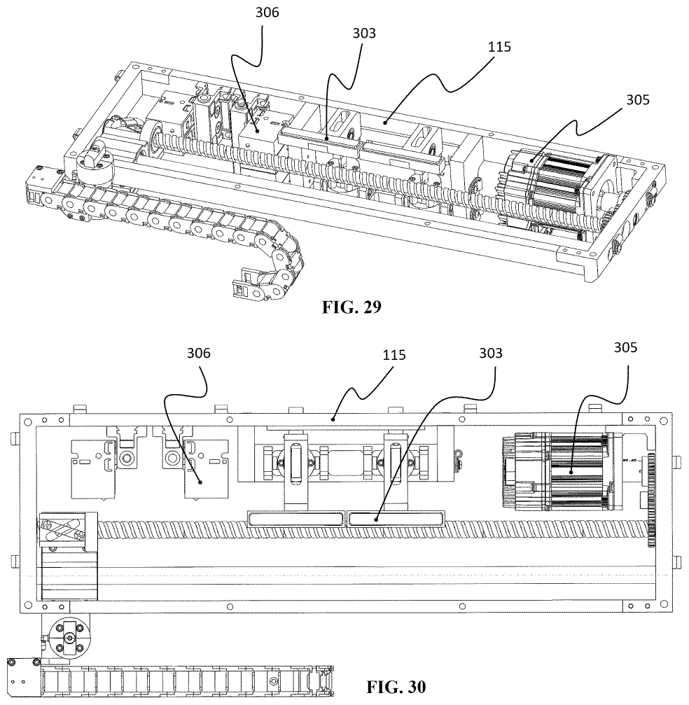

FIG. 29 shows an example embodiment of container transfer system 115 which is used to move and secure containers on transporter 108, sled 156 and kiosk 170. Container transfer system 115 consisting of a braking system 303 a motion control system 305 and one or more pneumatic solenoid/s 306 to actuate pneumatic actuators in the braking system 303 and motion control system 305.

FIG. 30 shows an example embodiment of the elements in FIG. 30 where container transfer system 115 is comprised of braking system 303 motion control system 305 as well as one of more solenoids 306.

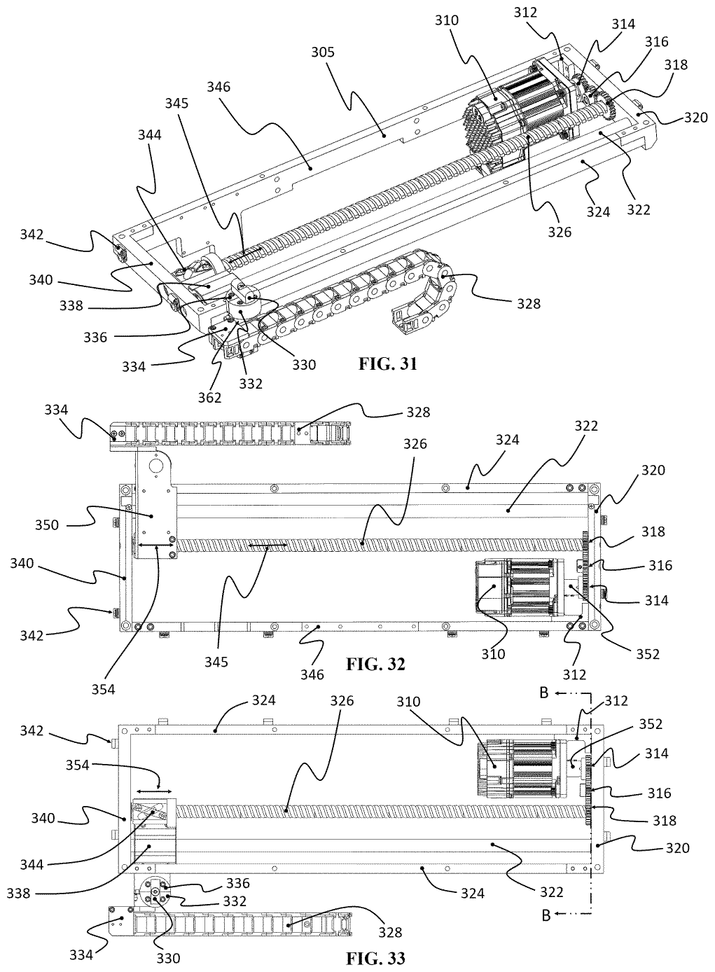

FIG. 31 shows an example embodiment of the motion control system 305 wherein transfer motor 310 attached to mounting bracket 312, rotates drive gear 314 which in turn rotates idle gear 316 and then driven gear 318. Driven gear 318 being affixed to ball screw 326 causes ball screw 326 to rotate which in turn causes ball nut 344 to move up or down the axis of the ball screw 326 with axial motion of ball nut 345 depending on the rotation direction of transfer motor 310. The assembly of motion control system is held together by left support frame 346, right support frame 324, front support frame 320 and back support frame 340. Other components of the motion control system 305 which are shown are linear guide block 338 which rides on linear guide rail 322 and container engagement pin 330, pneumatic actuator 362, left guide 336 and right guide 332, cable guide mount 334 and cable guide 328. At least one wire holder 342 may be used to secure wiring to the motion control system 305.

FIG. 32 shows an example embodiment of the motion control system 305 where transfer bracket 350 is affixed to ball nut 344, linear guide block 338 and pneumatic actuator 362, such that as ball screw 326 is rotated in either direct by transfer motor 310 and ball nut 344 is moved axially along axial motion of ball nut 345 it carries with it and creates forward and reverse motion 354 in turn and as an assembly linear guide block 338 and pneumatic actuator 362, to which container engagement pin 330, right guide 332 and left guide 336 are attached. Cable guide mount 334 is also affixed to transfer bracket 350 causing cable guide 328 to move with transfer bracket 350.

FIG. 33 shows an example embodiment of motion control system 305 for greater clarification.

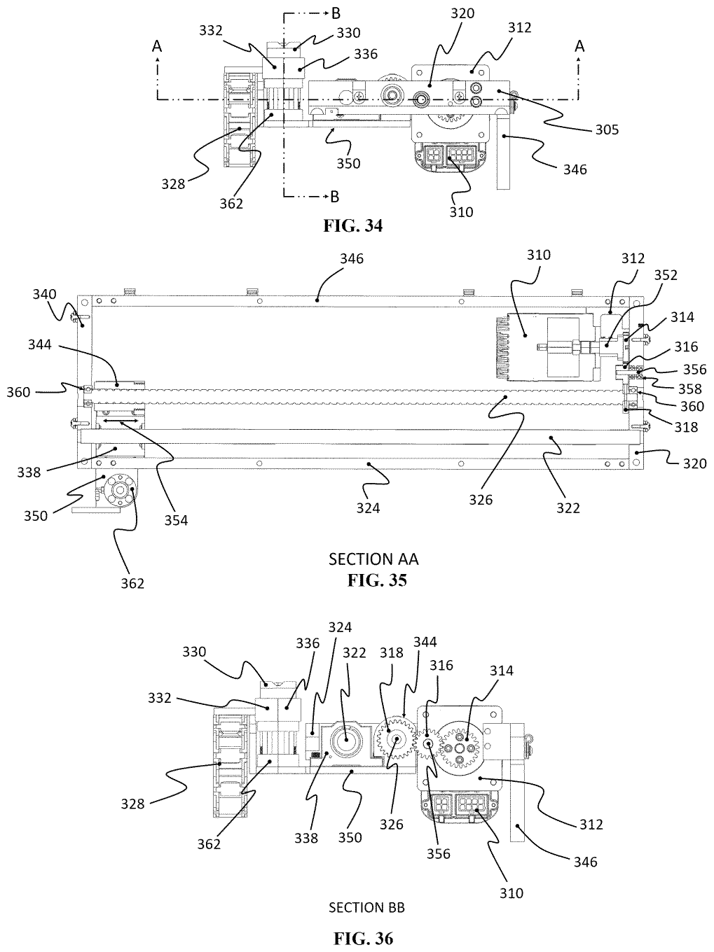

FIG. 34 shows an example embodiment of motion control system 305 from the direction of front support frame 320 for greater clarification and to show section AA.

FIG. 35 shows an example embodiment of motion control system 305 showing greater detail of the mounting of components. Where idle gear shaft 356 is affixed to idle gear 316 and idle gear shaft 356 is allowed to rotate in at least one idle gear bearing 358 and ball screw 326 is allowed to rotate by being inserted into ball screw bearing 360.

FIG. 36 shows an example embodiment of the interplay of drive gear 314, idle gear 316 and driven gear 318. Also shown is transfer bracket 350 affixed to pneumatic actuator 362, linear guide block 338 and ball nut 344, which move as a single assembly.

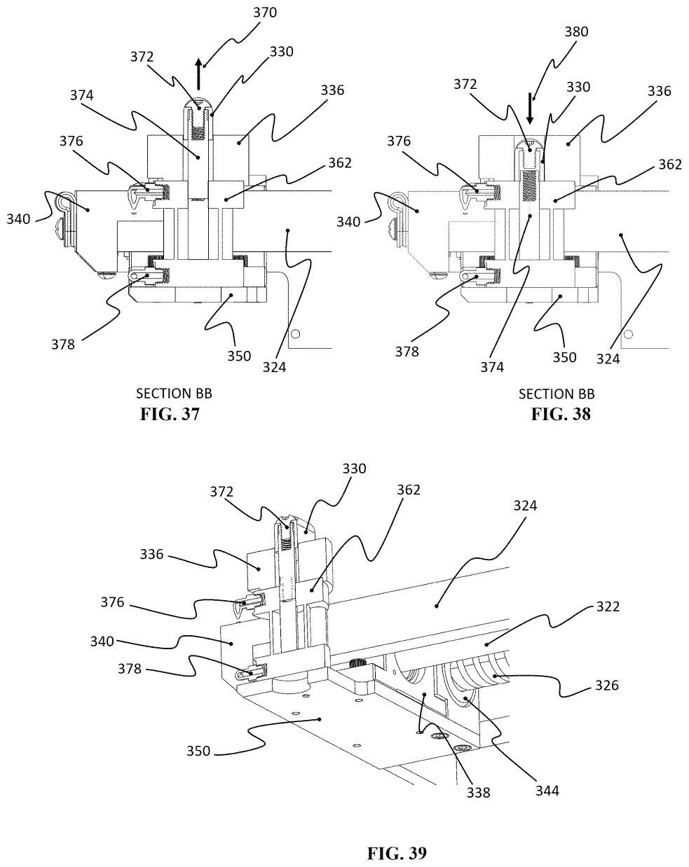

FIG. 37 shows an example embodiment of the function of pneumatic actuator 362 of FIG. 34 along line BB. This view shows container engagement pin 330 in its upper most position along path extended motion 370, having been moved by pneumatic actuator shaft 374, by applying pneumatic pressure to extend pneumatic inlet fitting 378 and allowing pressure to release from retract pneumatic inlet fitting 376. Engagement pin 330 is affixed to pneumatic actuator shaft 374 by way of engagement pin screw 372. Shown in this section view is left guide 336 which works in conjunction with right guide 332 (not shown) guide and support engagement pin 330.

FIG. 38 shows an example embodiment of the function of pneumatic actuator 362 of FIG. 34 along line BB. This view shows container engagement pin 330 in its lower most position along path extended motion 370, having been moved by pneumatic actuator shaft 374, by applying pneumatic pressure to retract pneumatic inlet fitting 376 and allowing pressure to release from extend pneumatic inlet fitting 378. Engagement pin 330 is affixed to pneumatic actuator shaft 374 by way of engagement pin screw 372. Shown in this section view is left guide 336 which works in conjunction with right guide 332 (not shown) guide and support engagement pin 330.

FIG. 39 shows an example embodiment of the interplay of the various features of motion control system 305

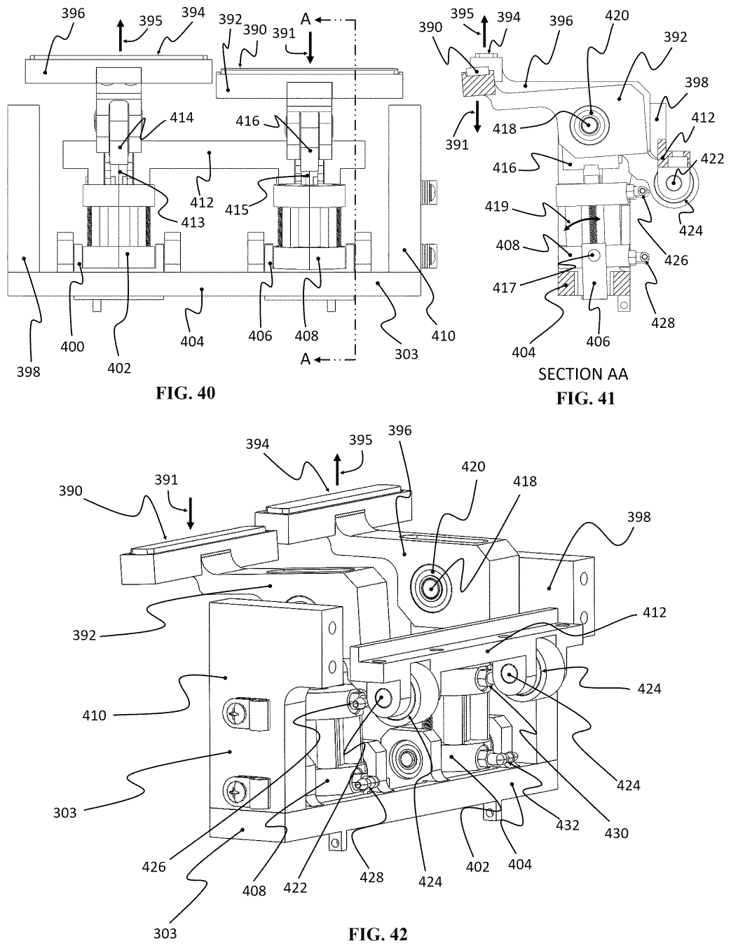

FIG. 40 shows an example embodiment of braking system 303 with one brake engaged and one brake disengaged. Braking system 303 has a right pneumatic actuator 408 mounted on right actuator pivot 406 and right actuator pivot 406 is allowed to pivot within brake main support 404. Right pneumatic actuator 408 having right actuator shaft 415 which connects to right brake pivot 416 which in turn connects to right brake clevis 392 which holds right brake pad 390. This right assembly is shown in the retract brake 391 position. Braking system 303 has a left pneumatic actuator 402 mounted on left actuator pivot 400 and left actuator pivot 400 is allowed to pivot within brake main support 404. Left pneumatic actuator 402 having left actuator shaft 413 which connects to left brake pivot 414 which in turn connects to left brake clevis 396 which holds left brake pad 394. This right assembly is shown in the extend brake 395 position. The aforementioned features are support by a structure consisting of main brake support 404, left support structure 398, right support structure 410 and brake clevis pivot 412.

FIG. 41 shows an example embodiment of pneumatic cylinder 408 and when it is in the retract brake 391 position. Right pneumatic actuator 408 retracts when pneumatic pressure is applied to right actuator retract inlet 426 and right actuator extend inlet 428 is allowed to vent to atmosphere. Main brake support 404 and brake clevis pivot 412 are fixed relative to right pneumatic actuator 408 for this reason, as the actuator retracts or extends it must be able to swing through actuator arc 419, about right pivot center 417. As right pneumatic actuator pivots about right pivot center 417 through actuator arc 419, right brake pivot 416 is allowed to rotate relative to right brake clevis 392 by way of clevis pivot front pin 418 and clevis pivot front bearing 420. Right brake clevis 392 also pivots about fixed brake clevis pivot 412 by way of clevis pivot back pin 422 and clevis pivot back bearing 424. Right pneumatic actuator 408 can conversely be extended by applying pneumatic pressure to right actuator extend inlet 428 while allowing right actuator retract inlet 426 to vent to atmosphere. The aforementioned method of extending or retracting the brake can be used on the left brake as well.

FIG. 42 shows an example embodiment of brake assembly 303 for greater clarification of the shown features. Left pneumatic actuator 404 may be extended by applying pneumatic pressure to left actuator extend inlet 432 while allowing left actuator retract inlet 430 to vent to atmosphere. Similarly, the left pneumatic actuator may be retracted by applying pneumatic pressure to left actuator retract inlet 430 and allowing left actuator extend inlet 432 to vent to atmosphere. In FIGS. 40, 41, and 42 right brake is shown in extend brake 395 position.

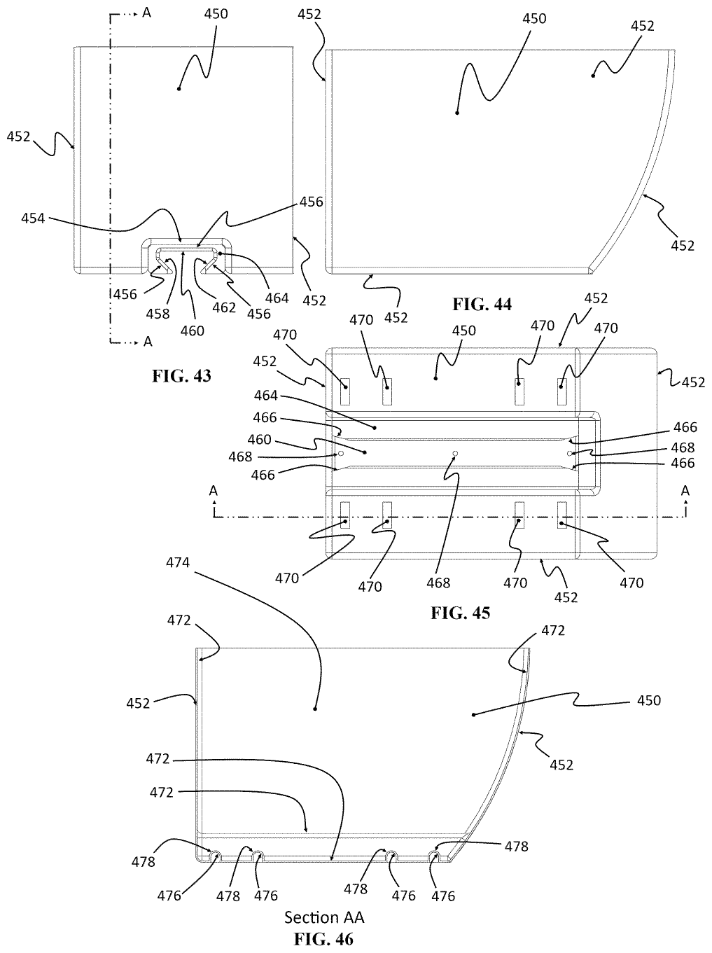

FIG. 43 shows an example embodiment of container 450 having a container wall outer face 452 which defines the outer confines of the container 450. Container 450 has a motion restraint recess 454 containing dovetail structure 464 which has dovetail lead in taper 456 to allow for easy transfer to other vehicles or kiosk. Dovetail structure 464 has dovetail left lower face 458, dovetail right lower face 452 and dovetail upper face 460.

FIG. 44 shows an example embodiment of container 450 for greater clarification of features.

FIG. 45 shows an example embodiment of container 450 where motion control attachment detents 470 can be seen. Dovetail structure 464 is affixed to container 450 within motion restraint recess 454 by way of fastener attachment points 468. Dovetail structure 464 also has dovetail lateral lead in tapers 466 to allow for easy transition to other vehicles or kiosk.

FIG. 46 shows an example embodiment of internal volume 474 for holding cargo. Internal volume 474 being defined by container wall inner faces 472. While a lid is not shown in this example, container 450 may optionally have a lid which will also have an inner and outer wall face. Container 450 has detents 470 with detent inner structure 476 and detent outer wall which in this example is horseshoe shaped but may be of any shape of configuration to allow for easy holding or attachment by an automated motion control system of means.

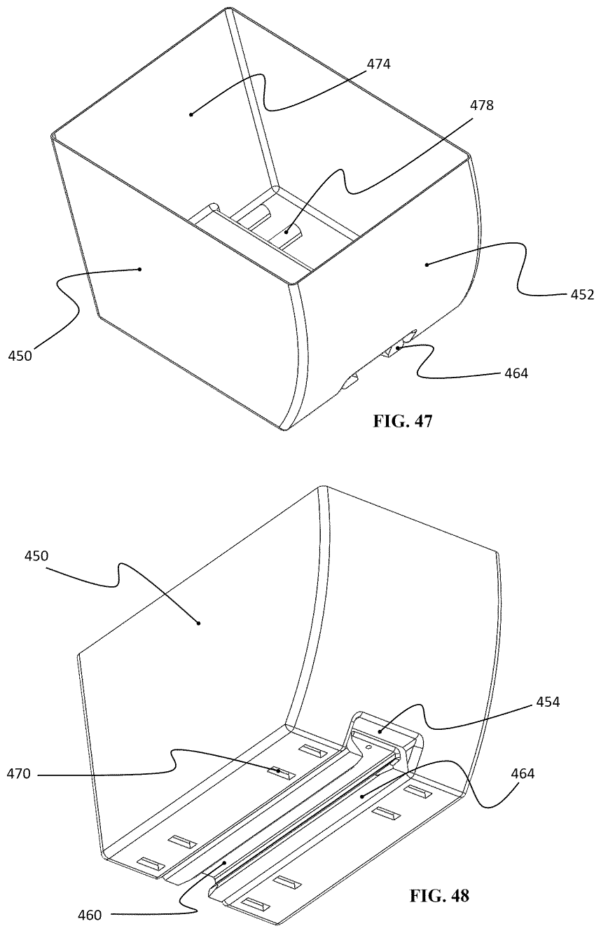

FIG. 47 shows an example embodiment of container 450 for greater clarification of features.

FIG. 48 shows an example embodiment of container 450 for greater clarification of features.

FIGS. 43, 44, 45, 46, 47 and 48 show an example embodiment of a container which is designed with features which make it easy to move, manipulate or otherwise handle with automated robotic or motion control means or systems as well as transfer between vehicles and a kiosk. A container may be of any required size, shape, or configuration. Containers may have lids or other closure means, containers may have an interior space which is subdivided, or which can be subdivided. The interior of a container may have walls or partitions which apply a load to the contents of the container to better secure those contents or containers may have means of securing contents such as straps, elastic bands, spring loaded bars, walls, structures or frames, fasteners of any sort or any means generally to secure contents within a container. The dovetail 464 configuration of the container is designed to restrict 2 axes of motion, however, any configuration including but not limited to a T-shape configuration, a diamond configuration, a lollipop configuration, a square configuration, or any configuration generally that will restrict motion in at least one axis may be used. A container may have a volume or environment which is passively controlled where insulation of any sort may be use to line the interior of the container. A container may have an actively controlled internal volume such as that which may be created by a heating or cooling mechanism. Containers may have a sensor or many sensors to monitor the temperature of the contents, the position of the contents, chemical composition of the contents, or generally any sensor that may monitor any desired characteristic of the contents. This may also include cameras of any type. A container may have a handle or handles of any sort which makes it easy for a person to carry or it may have wheels for a person to roll the container. A container may have any configuration protruding from or extending into it making it easier for a motion system to attach itself to, to hold on to, or otherwise secure itself to the container, whether the motion system is a robot or robotic arm or a single axis motion system or multi-axis motion system. A container may have a means of communication or transmission to external means of receiving such communication or transmission such as a receiver or transmitter, concerning the status of the contents of the container, position of the container or any desired state of the container or its contents. Container may have a mechanical or electromechanical means of manipulation of the cargo within the container or the container itself. This mechanical or electromechanical means may be activated remotely or by some local control system and/or computer processing system within the container to affect a desired result such as moving cargo internally, stimulating cargo internally or any affect which is desired.

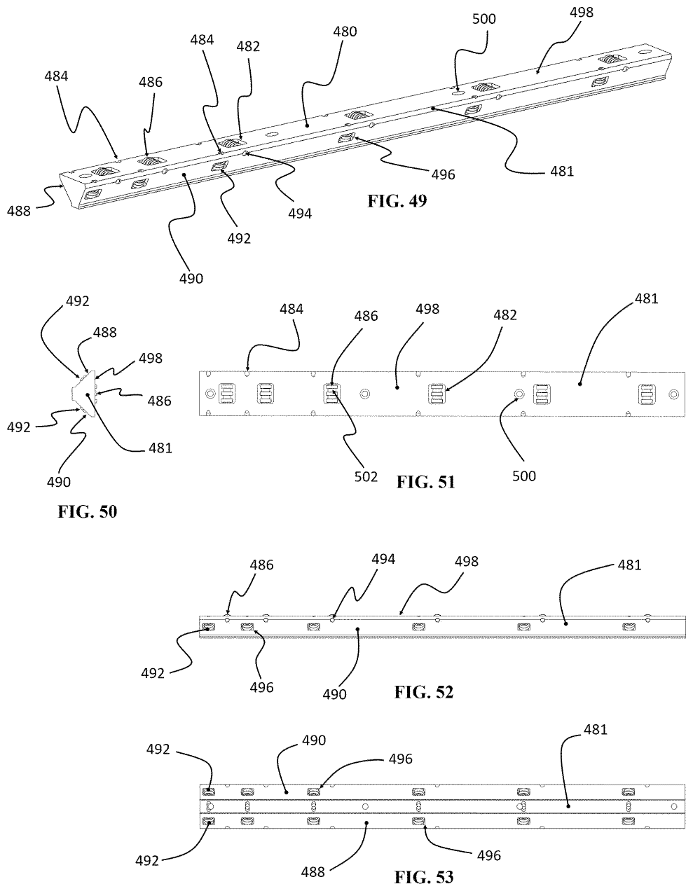

FIGS. 49, 50, 51, 52 and 53 shows an example embodiment of dovetail rail 480 having an upper face 498 in which upper bearing pockets 482 are positioned. Within the upper bearing pockets 482 are placed upper bearings 486, separated by spacers 502 and the upper bearings 486 and spacers 502 being held within upper bearing pocket 482 by upper bearing pin 494. Dovetail rail 480 also has tapered right face 490 and tapered left face 488 in which lateral bearing pockets 496 are placed and in which lateral bearings 492 are placed and held by lateral bearing pins 484. In the case of upper bearings 486 and lateral bearings 492, the bearings are situated to roll as surfaces and loads are placed on them.

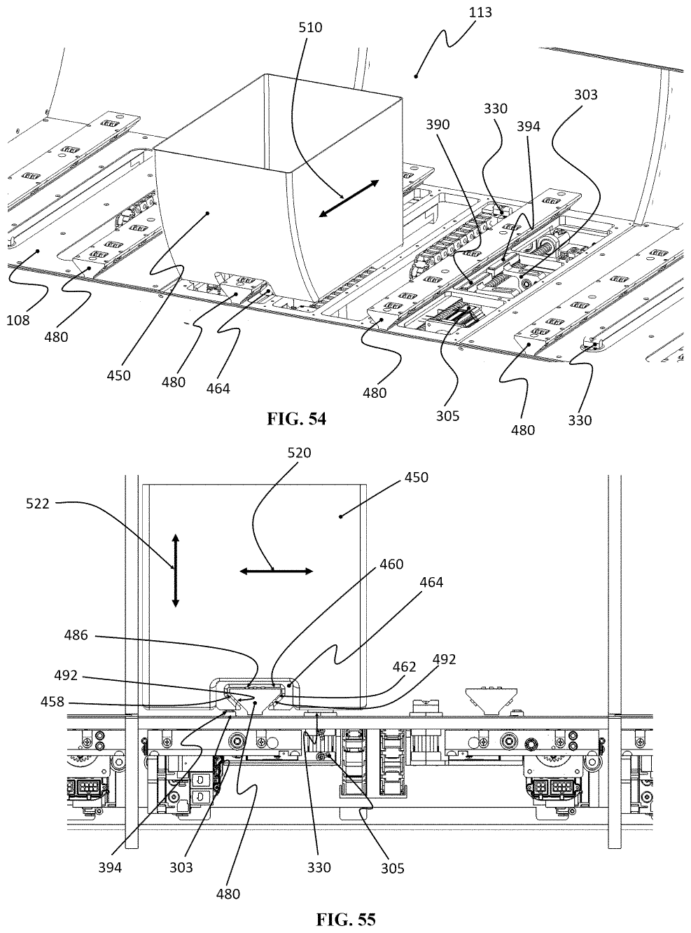

FIG. 54 is an isometric view of transporter 108 with cargo area 113 with at least 1 motion control system 305 and 1 braking system 303 visible. Also visible is container 450 riding on dovetail rail 480, with other dovetail rail/s 480 visible. Container 450 being constrained by dovetail rail 480 may move in the Z axis 510 if braking system 303 is disengaged by retract brake 391 motion or container 450 may be held along Z axis 510 if braking system 303 is engaged by extend brake 395 motion.

FIG. 55 shows a orthogonal front view of FIG. 54 where container 450 is held on dovetail rail 480 and constrained in the X axis 520 and Y axis 522 the interface of upper bearings 486 to dovetail upper face 460 and the interface of lateral bearings 492 and dovetail right lower face 462 and dovetail left lower face 458. Also shown is motion control system 305 and container engagement pin 330, engaged with container. Also shown is braking system 303 and left brake pad 394 in the extend brake 395 position thus locking container 450 in all axes of motion. If left brake pad 394 were in the retract brake 391 position container 450 would be free to move in the Z axis 510 direction by motion control system 305.

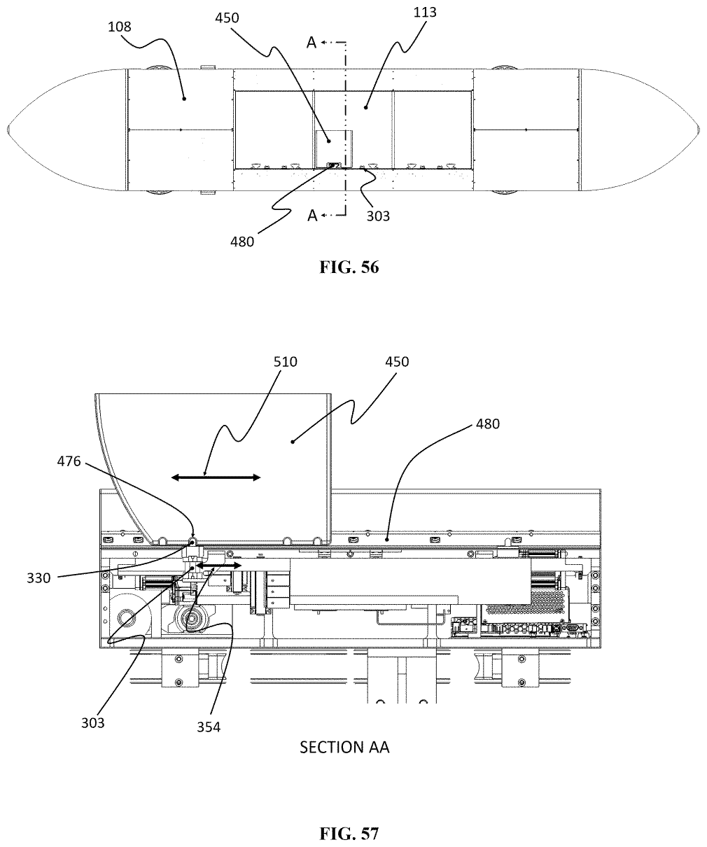

FIG. 56 shows an orthogonal side view of transporter 108 with container 450 on dovetail rail 480 and with motion control system 303 visible in cargo area 113.

FIG. 57 shows a partial section view of FIG. 56 along line AA where container 450 is engaged by motion control system 303 by way of container engagement pin 330 inserting into one of the detent inner structures 476. Container engagement pin 330 once inserted into detent inner structures 476, motion control system 303 is able to move container 450 in the Z axis 510 and along dovetail rail 480, as long as braking system 303 is in retract brake 391 position. Forward and reverse motion 354 of motion control system 303 having been previously described.

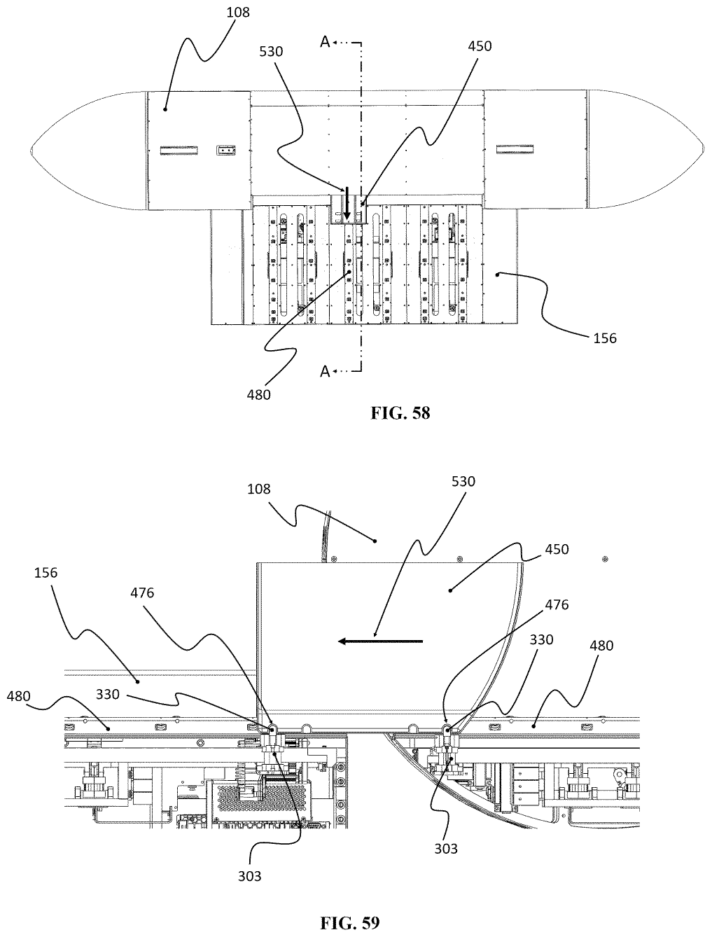

FIG. 58 shows an orthogonal top view of transporter 108 having been paralleled in motion by sled 156. With speed of transporter 108 having been matched by sled 156 and with location of dovetail rail system of transporter 108 matching that of dovetail rail system of sled 156. This view also shows container 450 moving from transporter 108 to sled 156 along forward motion of container 530.

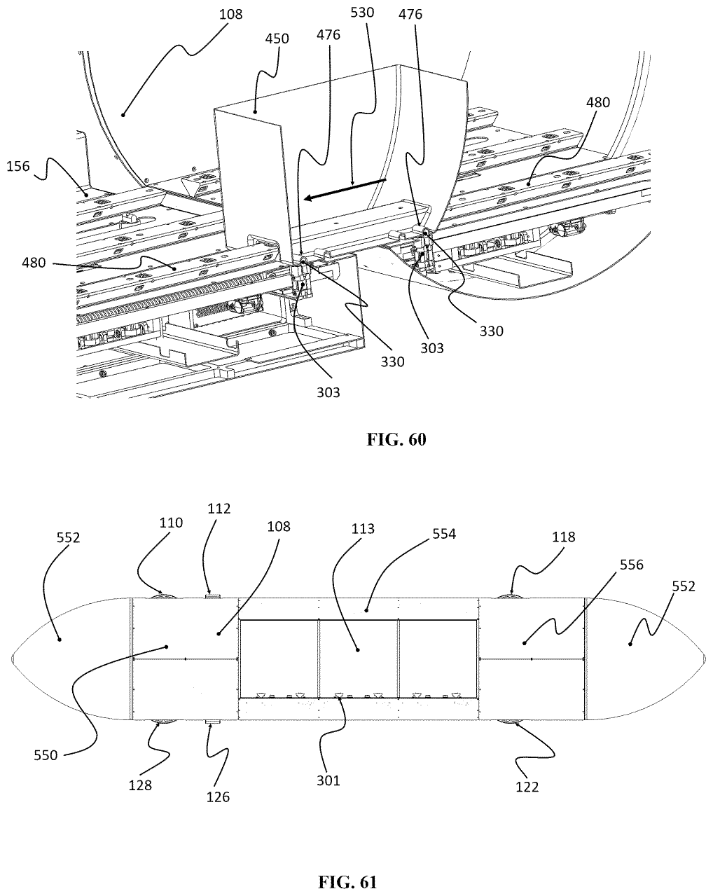

FIGS. 59 and 60 shows an example embodiment of a partial section view of FIG. 58 along line AA, with FIG. 59 being an orthogonal side view and FIG. 60 being and isometric side view, where transporter 108 is transferring container 450 to sled 156 by motion control system 303 on transporter 108 moving container 450 with forward motion of container 530 along dovetail rail 480 of transporter 108. At the same time motion control system 303 of sled 156, captures container 450 with container engagement pin 330 inserting into one of the detent inner structures 476 and likewise moving container 450 with forward motion of container 530 along dovetail rail 480 of sled 156. This transfer portion may also utilize timing, position, and any other relevant information of position control system 303 of transporter 156 and may be transmitted or caused to be transmitted to sled 156 so that motion control system 303 of sled 156 may be appropriately timed and positioned to receive container 450. Likewise, timing, position, and any other relevant information of position control system 303 of sled 156 may be transmitted or caused to be transmitted to sled 156 so that motion control system 303 transporter 156 may be appropriately timed and positioned to receive container 450. It is understood that, while motion control system 303 of transporter 108 and motion control system 303 of sled 156 are functionally similar, there may be differences in form or even function depending on the particular needs of transporter 108 or sled 156.

FIG. 61 shows an example embodiment of transporter 108, where cargo area 113 is visible. The main features of transporter 108 are upper front wheel 110, upper brush contact 112 drive wheel 128 lower brush contact 126 upper rear wheel 118, lower rear wheel 122, container transfer system 301, nose cone module 552, drive module 550, cargo module 554 and guide module 556.

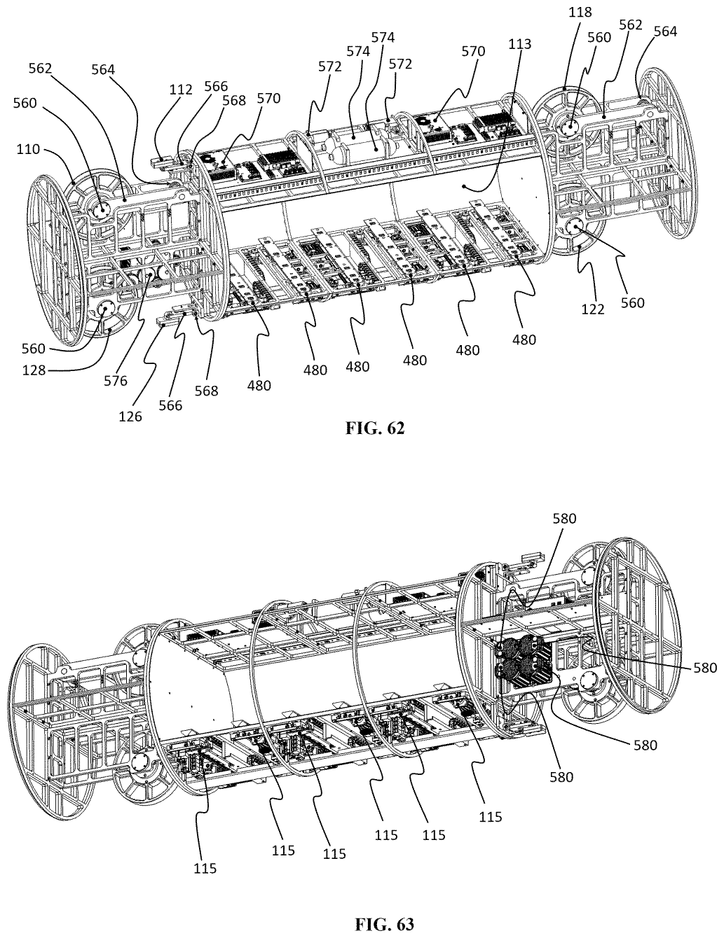

FIG. 62 shows an example embodiment of transporter 108 with various pieces of sheet metal removed as well as nose cone modules 552 in order to expose interior mechanisms for greater clarification. Upper front wheel 110 is held by spring loaded wishbone wheel holder 562 by way of rotational bearing 560 and wishbone pivot bearing 564. Upper brush contact 112 is held by spring loaded brush holder 566 and secured by brush holder pivot 568. Motor controller and microprocessor 570 may be used to control motors in container transfer system 115 or drive motors 576. Pneumatic compressor 572 is used to fill pneumatic tank 574 to provide pneumatic pressure to container transfer system 115. Upper rear wheel 118 is also held by spring loaded wishbone wheel holder 562 by way of rotational bearing 560 and wishbone pivot bearing 564. Lower rear wheel 122 and drive wheel 128 is held and allowed to rotate by rotational bearing 560. Drive wheel 128 is driven by way of drive gear train 576. Multiple dovetail rails 480 are shown.

FIG. 63 shows an example embodiment of transporter 108 with various pieces of sheet metal removed as well as nose cone modules 552 in order to expose interior mechanisms for greater clarification. Multiple container transfer systems 115 are shown and drive motors 580 which provide rotational energy to drive gear train 576 and ultimately to drive wheel 128, providing locomotion to transporter 108. It is understood that while a particular means of locomotion is shown in FIG. 62 and FIG. 63, any appropriate means of locomotion may be used to propel transporter 108. This may include but is not limited to electromagnetic propulsion, pneumatic propulsion, jet propulsion or even rocket or ion propulsion.

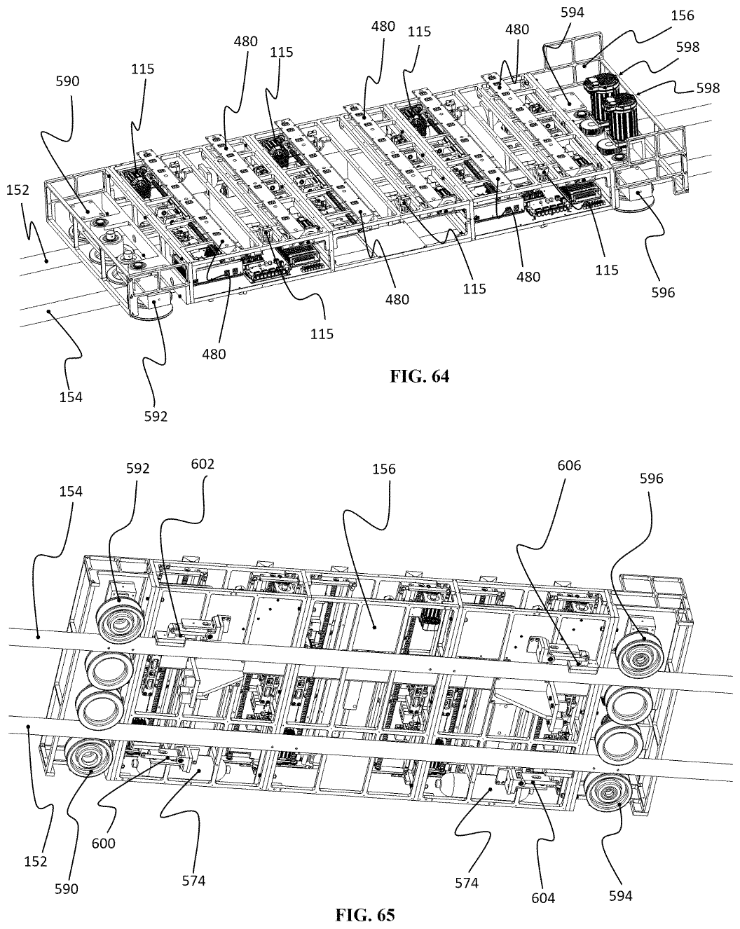

FIG. 64 and FIG. 65 show an example embodiment of sled 156 with various pieces of sheet metal removed in order to expose interior mechanisms for greater clarification. Sled 156 rides on inner rail, which is electrified, 152 and outer rail, which is electrified, 154 on front right swivel wheel assembly 590, front left swivel wheel assembly 592, rear right swivel wheel assembly 594 and rear left swivel wheel assembly 596. Rear right swivel wheel assembly 594 and rear left swivel wheel assembly 596 are driven by motors 598. Motors 598 receive power from front right electrical brush assembly 600, front left electrical brush assembly 602, rear right electrical brush assembly 604 and rear left electrical brush assembly 606. Multiple container transfer systems 115 are shown as well as multiple dovetail rail systems 480. It is understood that while a particular means of locomotion is shown in FIG. 64 and FIG. 65, any appropriate means of locomotion may be used to propel sled 156. This may include but is not limited to electromagnetic propulsion, pneumatic propulsion, jet propulsion or even rocket or ion propulsion.

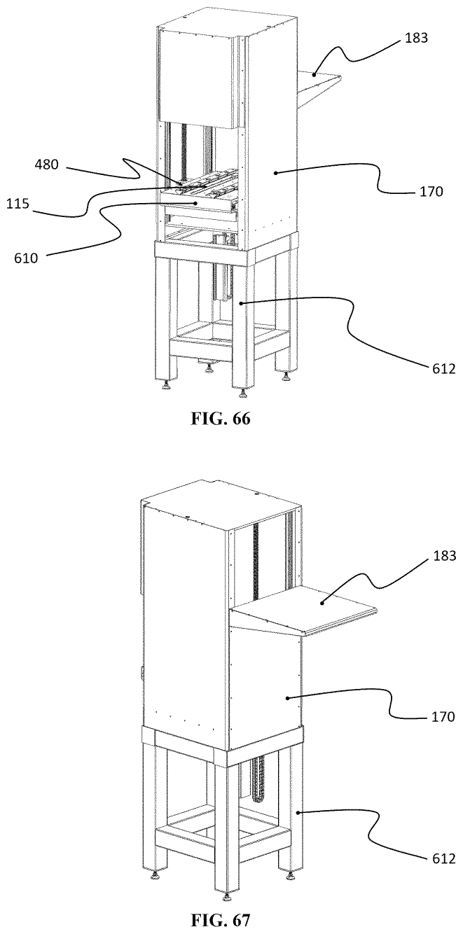

FIG. 66 shows an example embodiment of container transfer kiosk 170 on kiosk support frame 612 where kiosk send and receive platform 183 is visible. Within container transfer kiosk 170 can be seen elevator platform, 610 which contains at least 1 dovetail rail 480 and container transfer system 115.

FIG. 67 shows an example embodiment of container transfer kiosk 170 on kiosk support frame 612 where kiosk send and receive platform 183 is visible.

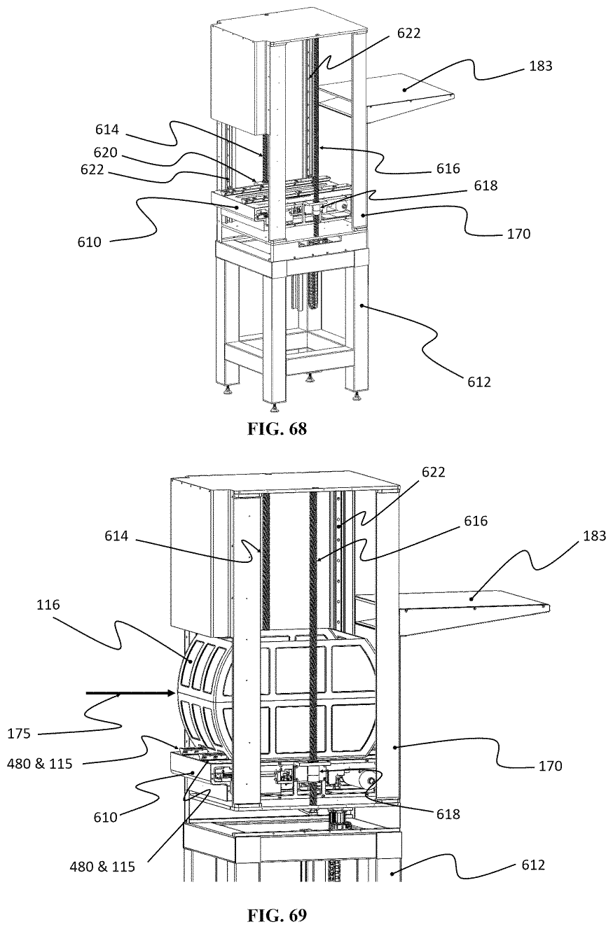

FIG. 68 shows an example embodiment of container transfer kiosk 170 with side panels removed to show internal working features. Within container transfer kiosk 170 is elevator platform 610 which is lifted and lowered by right ball nut 618 and left ball nut 620 when right elevator ball screw 616 and left elevator ball screw 614 are rotated. Elevator platform 610 is guided within elevator travel guides 622 and elevator platform 610 travels up or down.

FIG. 69 shows an example embodiment of container transfer kiosk 170 with side panels removed to show internal working features. Large container 116 is loaded onto elevator platform 610 and onto dovetail rail 480 and container transfer system 115 of elevator platform 610, usually from sled 156 (not shown). Large container moves with container transfer motion 2 onto elevator platform 610, driven by container transfer system 115 of sled 156 (not shown) and container transfer system 115 of elevator platform 610.

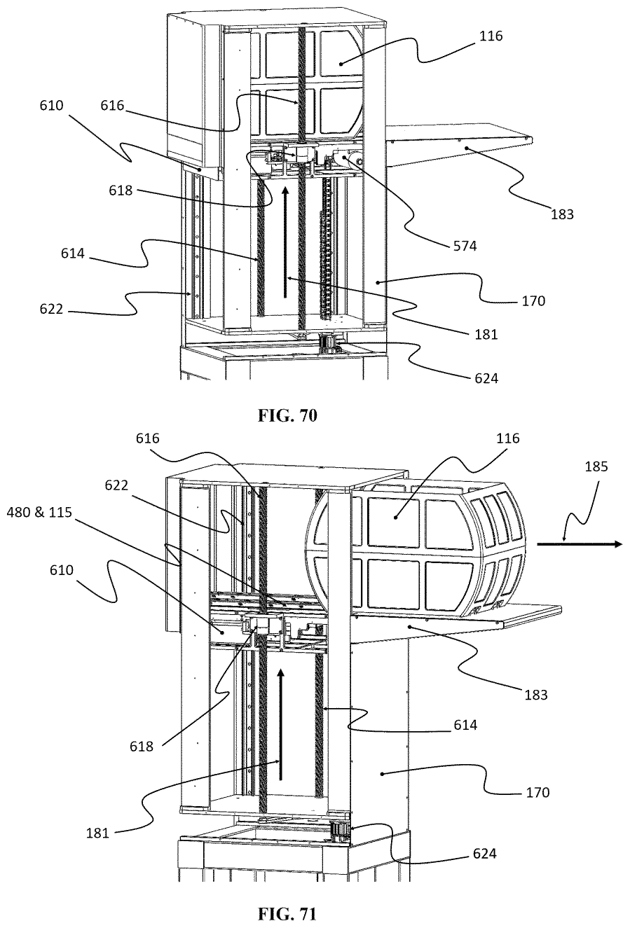

FIG. 70 shows an example embodiment of container transfer kiosk 170 with side panels removed to show internal working features. Large container 116 is lifted by elevator platform 610 with kiosk elevator up motion 181 by right ball nut 618 and left ball nut 620 when right elevator ball screw 616 and left elevator ball screw 614 are rotated by elevator motor 624. Elevator platform 610 is guided within elevator travel guides 622 and elevator platform 610 travels up or down.

FIG. 71 shows an example embodiment of container transfer kiosk 170 with side panels removed to show internal working features where elevator platform 610 has arrived at the kiosk send and receive platform 183 and container transfer system 115 moves container 116 onto kiosk send and receive platform 183 along container transfer motion 3, 185 so that the container 116 may now be accepted by a person.

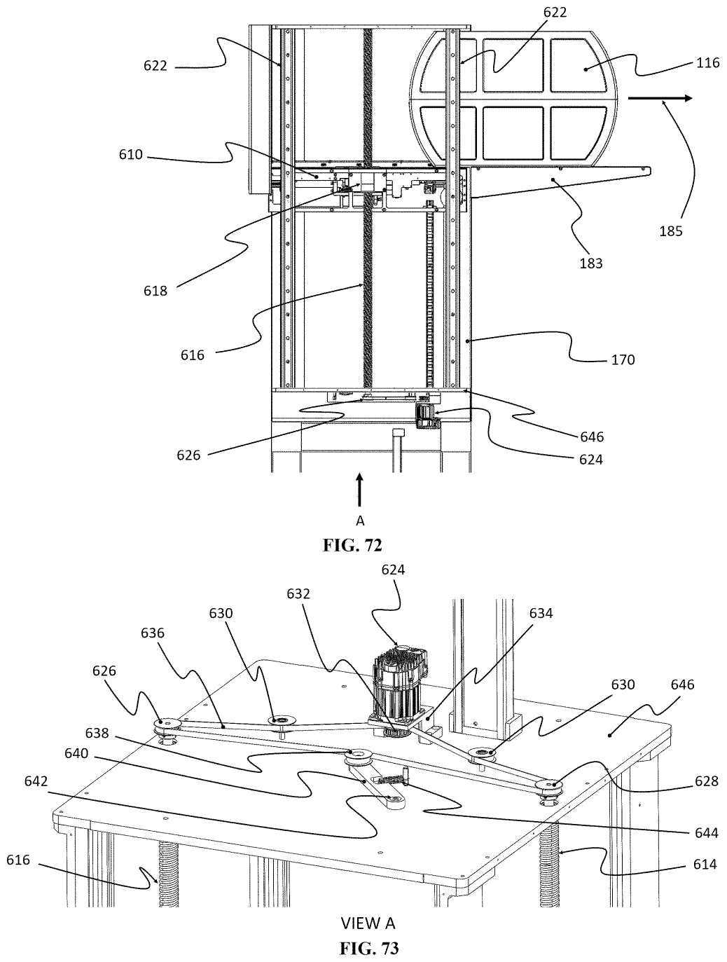

FIG. 72 shows an example embodiment of container transfer kiosk 170 with side panels removed to show internal working features where elevator platform 610 has arrived at the kiosk send and receive platform 183 and container transfer system 115 moves container 116 onto kiosk send and receive platform 183 along container transfer motion 3, 185 so that the container 116 may now be accepted by a person.

FIG. 73 shows an example embodiment of elevator base plate 646 where motor 624 is attached to elevator base plate 646 by way of motor mount 634. Left elevator ball screw 614 and right elevator ball screw 616 may be rotated simultaneously in the same direction by elevator motor 624 rotating motor pulley 632 which in turn drives elevator belt 636, which in turn drives right ball screw pulley 626 and left ball screw pulley 628 where elevator belt 636 is guided by idle pulleys 630 and tensioned by belt tensioner pulley 638 being pushed by belt tensioner arm 640 which pivots about belt tensioner pivot 642 and pulled by tension spring 644. Elevator motor 624 may operate in either rotational direction depending on whether elevator platform 610 is to be raised or lowered. It is understood that there may be a number of ways to transfer containers from a sled 156 to a person. Such other ways may include conveyor belts, escalator systems, self-propelled mechanisms or mechanisms which may slide a container in a flat surface and to a person or any combination thereof. These methods are envisioned by this disclosure.

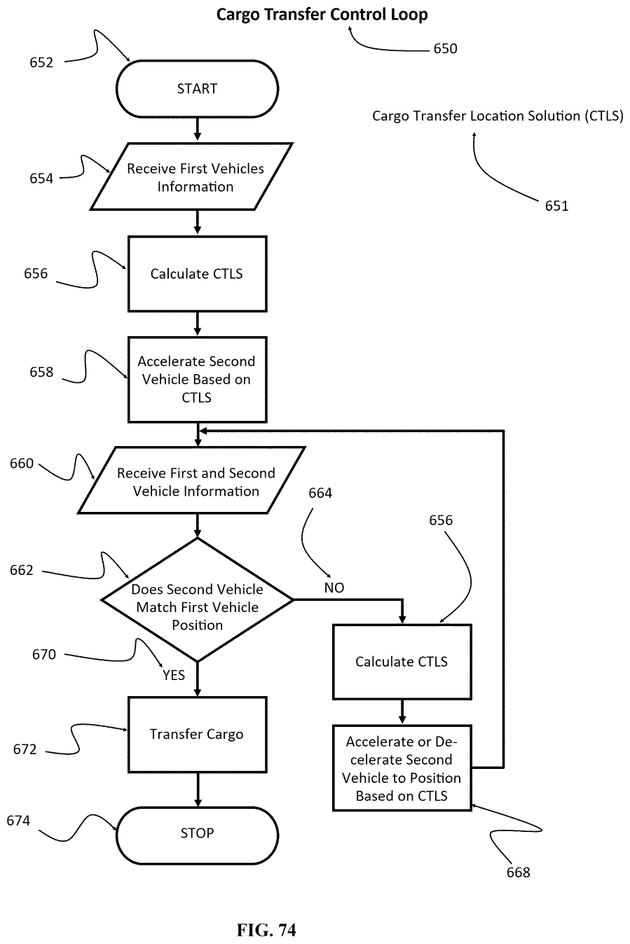

FIG. 74 shows an example embodiment of cargo transfer control loop 650 in which the basic logic of this operation has a start 652. This start. 652 does not imply that other operations could not have happened prior to start 562, whether computational or relating to logic, data acquisition, data management, data manipulation, data storage or any process, method, computation, or manipulation relevant to tasks in the cargo control loop 650. Cargo transfer control loop 650 receives first vehicle's information 654. This information may be the first vehicle's position, speed and direction or any information relevant to calculating cargo transfer location solution 651 sometimes referred to as CTLS. After having received first vehicle's information 654 and knowing at least the speed, position and direction or the first vehicle and knowing the initial speed of the second vehicle whether zero (0) or some other value, the calculate CTLS 656 step may be performed. The calculation may be done by any suitable computer or group of computers or microprocessors or the like in order to quickly obtain a CTLS. The computer or microprocessor may be on a first vehicle, a second vehicle, or some other location whether stationary or moving. Once a CTLS has been computed the next step is to accelerate the second vehicle based on CTLS 658. The CTLS information having been calculated in step, calculate CTLS 656, may be transferred to the second vehicle by any suitable method of information delivery such as radio transmission, optical transmission, or even hard wire if the second vehicle is stationary at the time of receiving the CTLS. The second vehicle accelerates at an appropriate acceleration and starts at an appropriate time such that as the second vehicle reaches the velocity of the first vehicle, the cargo area of the first vehicle and the cargo of the second vehicle should be substantially in alignment. However, there may be some mismatch in the cargo area of the first vehicle to the cargo area of the second vehicle. This mismatch may be caused by environmental conditions, mechanical conditions, cargo load conditions, and/or any number of variables which may cause error in the CTLS. For this reason, a check of locations in the step, receive first and second vehicle information 660 is used. This step will, at a minimum, receive location, speed, and direction information on the first vehicle and the second vehicle. The next step, does second vehicle match first vehicle position 662, is a logic check to see if the desired location of the first vehicle's cargo area matches the desired location of the second vehicle's cargo area. If yes 670 then the cargo may be transferred from one vehicle to the other. If no 664 then the step, calculate CLTS 656 is computed again based on the most recent position, speed and direction information having been received in step, receive first and second vehicle information 660. After the step, calculate CLTS 656, the next step, accelerate or decelerate second vehicle to position based on CTLS 668 is performed. This step allows the second vehicle to make the necessary adjustments to bring the desired location of the cargo area of the first vehicle into alignment with the desired location of the second vehicles cargo area. Once complete, the loop is reentered at step, receive first and second vehicle information 660, to confirm that cargo area locations match within an acceptable position tolerance, suitable to allow cargo transfer. This loop repeats until an acceptable position is achieved and the transfer of cargo 672 may be completed. This loop then goes to a stop 674. Although the loop has stopped there may be any number of computations, operations, tasks accomplished, data transmissions or data receives by the first vehicle, the second vehicle or any vehicle or any location.

What is claimed is:

1. A method for autonomously transferring cargo while in motion comprising:
providing a first autonomous vehicle with a first cargo area configured to carry a cargo container and traveling at a first speed along a first path;
providing a second autonomous vehicle having a second cargo area configured to carry the cargo container, with the second autonomous vehicle configured to accelerate, decelerate, and travel at a second speed along a second path;
loading autonomously, the cargo container within the second cargo area of the second autonomous vehicle;
receiving information of a first position, a first speed, and a first direction of the first autonomous vehicle and responsive to receiving information of the first autonomous vehicle position, speed, and direction, calculating by one or more processors a cargo transfer location solution;
accelerating, based on the cargo transfer location solution, the second autonomous vehicle to the second speed along the second path to within a cargo transfer location of the first autonomous vehicle;
updating the cargo transfer location solution by receiving information of the first position, first speed, and the first direction of the first autonomous vehicle and comparing it by one or more processors to a second location, second speed, and second direction of the second autonomous vehicle and changing the second autonomous vehicle's position to match a desired first autonomous vehicle's position;
transferring autonomously the cargo container from the second cargo area of the second autonomous vehicle to the first cargo area of the first autonomous vehicle.

2. The method of claim 1 wherein the first vehicle travels on a rail type system.

3. The method of claim 1 wherein the second vehicle travels on a rail type system.

4. The method of claim 1 wherein the first vehicle travels on or within a system where axes of motion are constrained such that the first vehicle is kept on the first path.

5. The method of claim 1 wherein the second vehicle travels on or within a system where axes of motion are constrained such that the second vehicle is kept on the second path.

6. The method of claim 1 wherein the cargo container may be restrained within the first vehicle's first cargo area in at least one axis of motion.

7. The method of claim 1 wherein the cargo container may be restrained within the second vehicle's second cargo area in at least one axis of motion.

8. The method of claim 1 wherein the cargo container may be transferred by a motion control system.

9. The method of claim 1 wherein the cargo container may be transferred by a robotic arm.

10. A method for autonomously transferring cargo while in motion comprising:
providing a first autonomous vehicle carrying a cargo container in a cargo area configured to carry the cargo container and traveling at a first speed along a first path;
providing a second autonomous vehicle having a second cargo area configured to carry the cargo container, with the second autonomous vehicle configured to accelerate, decelerate, and travel at a second speed along a second path;
receiving information of a first position, a first speed, and a first direction of the first autonomous vehicle and responsive to receiving information of the first autonomous vehicle's position, speed, and direction, calculating by one or more processors a cargo transfer location solution;
accelerating, based on the cargo transfer location solution, the second autonomous vehicle to the second speed along the second path to within a cargo transfer location of the first autonomous vehicle;
updating the cargo transfer location solution by receiving information of the first position, first speed, and the first direction of the first autonomous vehicle and comparing it by one or more processors to a second location, second speed, and second direction of the second autonomous vehicle and changing the second autonomous vehicle's position to match a desired first autonomous vehicle's position;
transferring autonomously the cargo container from the first cargo area of the first autonomous vehicle to the second cargo area of the second autonomous vehicle;
decelerating the second autonomous vehicle to a stop and autonomously unload the cargo container.

11. The method of claim 10 wherein the first vehicle travels on a rail type system.

12. The method of claim 10 wherein the second vehicle travels on a rail type system.

13. The method of claim 10 wherein the first vehicle travels on or within a system where axes of motion are constrained such that the first vehicle is kept on the first path.

14. The method of claim 10 wherein the second vehicle travels on or within a system where axes of motion are constrained such that the second vehicle is kept on the second path.

15. The method of claim 10 wherein the cargo container may be restrained within the first vehicle's first cargo area in at least one axis of motion.

16. The method of claim 10 wherein the cargo container may be restrained within the second vehicle's second cargo area in at least one axis of motion.

17. The method of claim 10 wherein the cargo container may be transferred by a motion control system.

18. The method of claim 10 wherein the cargo container may be transferred by a robotic arm.
